(19) United States
(12) Patent Application Publication
(10) Pub. No.: US 2012/0031760 A1
(43) Pub. Date: Feb. 9, 2012

(54) METHOD AND APPARATUS FOR REMOVAL OF PARTICLES FROM LUBRICATING OIL

(76) Inventors: Nageswara Rao Cheekala, Perrysburg, OH (US); Stephen G. Tosh, Whitehouse, OH (US); Daniel E. Bause, Flanders, NJ (US); Ronald P. Rohrbach, Flemington, NJ (US); Brian K. Artz, Maumee, OH (US); Peter D. Unger, Morristown, NJ (US)

(21) Appl. No.: 13/104,550

(22) Filed: May 10, 2011

Related U.S. Application Data
(63) Continuation-in-part of application No. 12/606,711, filed on Oct. 27, 2009.
Application No. 12/606,711 is a continuation-in-part of application No. 11/854,295, filed on Sep. 12, 2007.
(60) Provisional application No. 61/470,214, filed on Mar. 31, 2011.
(60) Provisional application No. 61/333,239, filed on May 10, 2010.
(60) Provisional application No. 61/108,632, filed on Oct. 27, 2008.
(60) Provisional application No. 60/825,397, filed on Sep. 12, 2006.

(51) Int. Cl. C10G 32/02; B04B 5/10; B03C 5/02

(52) U.S. Cl. 204/562; 204/665

(57) ABSTRACT

A method for removing soot, sludge and other insoluble particulates from an engine oil is provided, the method comprising: disposing an oil containing the particulates between a pair of electrodes, wherein one of the electrodes is a positive electrode; wrapping a surface of the positive electrode with a media, wherein the media is configured to collect a portion of the particulates drawn towards the positive electrode; applying a current to the electrodes for a period of time, wherein portions of the particulates agglomerate in the media. Also, disclosed herein is a filter for removing soot, sludge and other insoluble particulates from an engine oil.

### CROSS REFERENCE TO RELATED APPLICATIONS

This application claims the benefit of U.S. Provisional Patent Application Ser. No. 61/333,239 filed May 10, 2010, the contents of which are incorporated herein by reference thereto.

This application also claims the benefit of U.S. Provisional Patent Application Ser. No. 61/470,214 filed Mar. 31, 2011, the contents of which are incorporated herein by reference thereto.

This application is a continuation in part of U.S. patent application Ser. No. 12/606,711, filed Oct. 27, 2009, which claims the benefit of U.S. Provisional Patent Application Ser. No. 61/108,632 filed Oct. 27, 2008 the contents each of which are incorporated herein by reference thereto.

This application is also a continuation in part of U.S. patent application Ser. No. 11/854,295 filed Sep. 12, 2007, which claims the benefit of U.S. Provisional Patent Application Ser. No. 60/825,397 filed Sep. 12, 2006, the contents each of which are incorporated herein by reference thereto.

### TECHNICAL FIELD

This application relates to an apparatus and method for removing soot, sludge and other insoluble particulates from lubricating oils, and more particularly this application relates to particulate removal through the use of electro-agglomeration.

### BACKGROUND

In modern automobiles, many types of fluid filters are common. An oil filter is a fluid filter used to strain the oil in the engine thus removing abrasive particles. Most such filters use a mechanical or ‘screening’ type of filtration, with a replaceable cartridge having a porous filter element therein, through which oil is repeatedly cycled to remove impurities such as small particles or dirt and metal. “Dirty” oil enters an oil filter under pressure, passes through the filter media where it is “cleaned,” and then is redistributed throughout the engine. This can prevent premature wear by ensuring that impurities will not circulate through the engine and reach the close fitting engine parts. Filtering also increases the usable life of the oil.

It is common for the normal operation of an internal combustion engine particularly that of a diesel engine, to result in the formation of contaminants. These contaminants include, among others, soot, which is formed from incomplete combustion of the fossil fuel, and acids that result from combustion. Both of these contaminants are typically introduced into the lubricating oil during engine operation and tend to increase oil viscosity and generate unwanted engine deposits, leading to increased engine wear.

The conventional solution to these problems has been to place various additives into lubricating oils, during their initial formulation. In order to combat soot-related problems, many conventional lubricating oils include dispersants that resist agglomeration of soot therein. These work well for a short period, but may become depleted. Additionally, and due to the solubility and chemical stability limits of these dispersants in the oil, the service lives of the lubricating oil and the oil filter are less than optimal.

In order to counteract the effects of acidic combustion products, many conventional motor oils include neutralizing additives known as over-based detergents. These are a source of TBN (total base number), which is a measure of the quantity of the over-based detergent in the oil, expressed in terms of the equivalent number of milligrams of potassium hydroxide that is required to neutralize all basic constituents present in 1 gram of sample. Higher TBN oils provide longer lasting acid neutralization. The depletion of TBN is an important limiting factor for many internal combustion engines, and in particular for heavy-duty applications with diesel engines.

In order to improve engine protection and to combat other problems, conventional lubricating oils often include one or more further additives, which may be corrosion inhibitors, antioxidants, friction modifiers, pour point depressants, detergents, viscosity index improvers, anti-wear agents, and/or extreme pressure additives. The inclusion of these further additives may be beneficial; however, with conventional methods, the amount and concentration of these additives are limited by the ability of lubricating oils to suspend these additives, as well as by the chemical stability of these additives in the oil.

In addition to trapping impurities and decontaminating oil, it is the role of the oil filter to ensure fast and efficient flow through its media. Oil is the life blood of an engine, and its constant flow is essential for proper lubrication of engine components and the prevention of friction, heat and wear. Engine components rely on the oil circulation system to deliver a steady and adequate supply of motor oil.

Accordingly, it is desirable to provide a method and apparatus for removing the oil soot, sludge and other insoluble particulates from the oil.

### SUMMARY

Disclosed herein is an apparatus and method for removing soot, sludge and other insoluble particulates from the engine oil. In one exemplary embodiment, a method for removing the particulates from an engine oil is provided, the method comprising: disposing an oil containing the particulates between a pair of electrodes, wherein one of the electrodes is a positive electrode; wrapping a media on the positive electrode, wherein the media is configured to collect a portion of the particulates drawn towards the positive electrode; applying an electric current to the electrodes for a period of time, wherein portions of the particulates agglomerate in the media and removing the agglomerated particulates from the oil.

In another embodiment, a method for removing soot from engine oil is provided, the method including the steps of: disposing an oil containing soot particles between a pair of electrodes; applying a DC or AC current to the pair of electrodes for a period of time to generate an electric field, wherein the electric field causes the soot particles to agglomerate resulting in a larger average particle size of the soot particles; and removing the soot particles by a filtering process, wherein the filtering process comprises application of a centrifugal force to the oil, wherein the centrifugal force causes the soot particles to be disposed in a media disposed on one of the pair of electrodes that is removable from the oil.

In another embodiment, a filter for removing soot particles from an engine oil having soot particles disposed therein is provided, the filter having: a housing having an inlet and an outlet defining a flow path through a chamber defined by the housing; a pair of electrodes disposed in the flow path, the electrodes being disposed in the flow path after the inlet, the pair of electrodes being electrically coupled to a DC current, wherein an electric field is generated by the pair of electrodes and one of the pair of electrodes is a positive electrode, wherein the electric field causes a portion of the soot particles to agglomerate on the positive electrode, wherein at least the positive electrode is removable from the filter to allow removal of the soot particles agglomerated on the positive electrode; and a media applied to the surface of the positive electrode, wherein the media is configured to improve the collecting efficiency of the agglomerated portion of soot particles on the positive electrode.

The above-described and other features and advantages of the present application will be appreciated and understood by those skilled in the art from the following detailed description, drawings, and appended claims.

### BRIEF DESCRIPTION OF DRAWINGS

FIGS. 1 and 2 illustrate a pair of electrodes and a particulate agglomeration process;

FIG. 3 is a graph illustrating the effect of the electric field on the centrifugal sedimentation of used oil;

FIG. 4 is a graph illustrating the effect of the electric field on the soot level of used oil;

FIG. 5 is a graph illustrating the effect of electro-agglomeration on the TBN of an oil;

FIG. 6 is a graph illustrating the time course of electro-agglomeration;

FIG. 7 is a graph illustrating the soot removal and electrode soot loading of used oil in accordance with an exemplary embodiment of the present invention;

FIG. 8 is a schematic illustration of a filter constructed in accordance with an exemplary embodiment of the present invention;

FIG. 9 is a schematic illustration of a filter constructed in accordance with an alternative exemplary embodiment of the present invention;

FIG. 10 is a schematic illustration of a filter constructed in accordance with yet another alternative exemplary embodiment of the present invention;

FIG. 11 is a schematic illustration of a filter constructed in accordance with yet another alternative exemplary embodiment of the present invention;

FIG. 12 is a schematic illustration of a filter constructed in accordance with still another alternative exemplary embodiment of the present invention;

FIG. 13 is a schematic illustration of a filter constructed in accordance with yet another alternative exemplary embodiment of the present invention;

FIG. 13A is a schematic illustration of a filter system constructed in accordance with yet another alternative exemplary embodiment of the present invention;

FIG. 14 is a cross sectional view of a filter constructed in accordance with an exemplary embodiment of the present invention;

FIG. 15 is a cross sectional view of a filter constructed in accordance with an alternative exemplary embodiment of the present invention;

FIG. 16 is a partial cross-sectional view of the filter illustrated in FIG. 15; and

FIGS. 17A-25 illustrate still other exemplary embodiments of the present invention.

### DESCRIPTION OF EXEMPLARY EMBODIMENTS

A disadvantage to the use of centrifugal methods for soot and/or particulate removal is the relatively low efficiency as currently practiced. In accordance with an exemplary embodiment of the present invention methods and apparatus for soot, sludge and other insoluble particulates from an oil are provided. Non-limiting embodiments are directed to an oil filtration device (e.g., filter) that is configured to apply an electric field in accordance with an exemplary embodiment of the present invention. One non-limiting example of such an oil filtration device is found in U.S. patent application Ser. No. 11/854,295 filed Sep. 12, 2007, the contents of which are incorporated herein by reference thereto. Thereafter, the agglomerated soot and/or other particulates are removed via removal of a particulate-covered electrode, application of a centrifugal force, and/or subsequent filtration by a filtration media. In accordance with an exemplary embodiment, any one of the three methods may be employed alone or in combination with one another. Reference is also made to U.S. Patent Application Publication No. 2008/0060949 the contents of which are incorporated herein by reference thereto.

In accordance with an exemplary embodiment of the present invention, the application of a strong electric field to the oil will cause particulate agglomeration, thereby enhancing subsequent removal by centrifugation or other separation techniques. In one exemplary embodiment, the separation techniques may employ subsequent filtration using a filtration media, removal of an electrode or electrodes, that apply the electric field when particulates have agglomerated or adhered to the electrode itself or any combination of the foregoing processes. In accordance with an exemplary embodiment, the process of electro-agglomeration will cause the average soot particulate or other particulate size to increase. This will cause an increase of the sedimentation or collection rate upon application of a centrifugal force or other filtration technique.

In accordance with an exemplary embodiment, the lubricating oil containing soot, sludge and other insoluble particulates is positioned between two electrodes connected to a DC power supply. A direct current of up to 5 kV is applied to the electrodes. Of course, currents greater or less than 5 kV may be used. The resulting strong electrical field will cause the soot, sludge and other insoluble particulates from the oil to agglomerate on the positive electrode. To enhance particulate agglomeration, a coating is applied to the surface of the positive electrode, wherein the coating is a soot-collecting agent having properties and configured to improve the collecting efficiency of the agglomerated soot or other particles on the positive electrode. The agglomerated particles may then be actively removed. In one exemplary embodiment, the positive electrode with the agglomerated particles may be simply removed and this electrode is either discarded or cleaned. A new electrode, or the cleaned electrode, is replaced into the oil filtration device which, in one embodiment, may comprise an oil filter mounted on an internal combustion engine, for example a diesel engine, wherein soot removal from the oil is desirable.

In another exemplary embodiment and by simply removing the electric field a partial or passive deagglomeration may result, wherein the partially agglomerated particulates will then be separated from the liquid oil phase by centrifugation or other separation method, which may include filtration through filtration media.

In accordance with an exemplary embodiment, a voltage potential is applied to electrodes connected to an electric power supply. In one non-limiting example, a voltage potential of up to 5 kV or less is applied to the electrodes. Of course, voltage potentials greater or less than 5 kV may be used. The strong electric field will cause the soot to agglomerate on the positive electrode. To enhance soot or other particle agglomeration, a coating is applied to the surface of the positive electrode, wherein the coating is a soot-collecting agent having properties and configured to improve the collecting efficiency of the agglomerated of soot particles on the positive electrode. This approach can serve as an effective means of reducing the soot level in the circulating oil and entails no further purification or post separation scheme. However, a portion of the soot or other particulates remaining in the liquid phase that is not collected on the electrode has been demonstrated to be preagglomerated resulting in a larger average particle size or diameter. This larger average particle diameter allows for the particulates to be more efficiently trapped by a filtration media of a filter disposed in a flow path of a filter constructed in accordance with the teachings of exemplary embodiments of the present invention.

Also, and in some instances, no agglomeration on the electrode is observed if the applied voltage is alternating in nature, however agglomeration does occur in the circulating oil. The partially agglomerated or preagglomerated soot not collected on the electrode can then be separated from the liquid oil phase by centrifugation or other downstream separation method.

The attached Figures illustrate various exemplary embodiments of the present invention. In one embodiment, and upon exposure to a strong electrical field, particles will pre-agglomerate or clump prior to or during a process of migration to the positive electrode. This will result in larger average particle size and would likely increase sedimentation and collection rate of the particles.

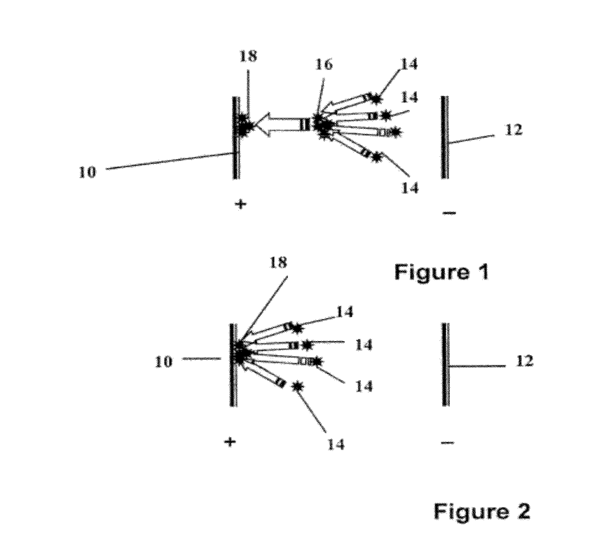

FIGS. 1 and 2 illustrate a pair of electrodes 10 and 12. Also shown are a plurality of soot particles 14. In accordance with an exemplary embodiment of the present invention and wherein an electrical field is generated by the pair of electrodes, soot particles 14 agglomerate into a mass of soot particles 16 shown in FIG. 1. Although soot particles 14 are shown it is also understood that exemplary embodiments of the present invention contemplate electro-agglomeration of other particles such as sludge and other insoluble particulates. Furthermore, the mass of soot particles is then attracted towards the positive electrode 10 shown as adhered particle 18. Alternatively and as shown in FIG. 2, the soot particles may agglomerate directly onto the positive electrode 10 to provide agglomerated particle 18 on the positive electrode. For example, the soot particles acquire charge and migrate to the positive (+) electrode in a one-by one fashion. The electrode includes a coating which is applied to the surface, wherein the coating is a soot-collecting agent having properties and configured to improve the soot-collecting efficiency on the surface of the positive electrode. In one exemplary embodiment, the electrodes are removably placed within a filter housing in fluid communication with an oil flow and as the positive electrode is loaded with soot the same can be removed and replaced as necessary. As will be discussed herein the filter may be a bypass filter or the electrodes may comprise part of a filter having other separation components (e.g., media and/or a centrifuge) or the filter comprising the electrodes is a part of a series of filters wherein the first filter comprises the electrodes and the subsequent filters contain the other separation components (e.g., media and/or a centrifuge).

In one alternative embodiment and for separation by filtration, this mechanism would likely require the use of alternating current in order to maintain agglomerates in the oil flow for downstream separation by centrifugation.

In accordance with an exemplary embodiment of the present invention the effect of electro-agglomeration was studied on centrifuge separation, soot levels over time and TBN.

In a first example a time-base study of the effect of an electric field on a sedimentation rate was performed wherein electrode soot loadings were observed.

### Example I

### Electro-Agglomeration

Effect of electric field on centrifugal sedimentation
rate

15,000 RPM at 25 C.
25,000 RPM at 40 C.

Change in equipment setup
Time-base study of effect of electric field on
sedimentation rate

Electro-agglomeration- Effect on Centrifugal Sedimentation
Power Supply

Hipotronics HD125 AC/DC Power Supply
25 kV/5 mA (adjustable) output current- set to 15 kV (DC)

Electrodes

60 × 60 mesh screen, 1 cm × 5.2 cm (w × l), spaced 1.5 cm apart

Oil

(~6.9 wt % soot)

PROTOCOL

Electrodes clamped vertically in 10 cc flask containing ~10 cc used
oil, no mixing
Applied 15 kV voltage for 90 minutes
2-3 g of electro-treated oil removed immediately and centrifuged:

15,000 rpm at 25 C. for 1 hour
25,000 rpm at 40 C. for 1 hour

Soot by TGA performed on spun and unspun electro-treated oil and
control oil

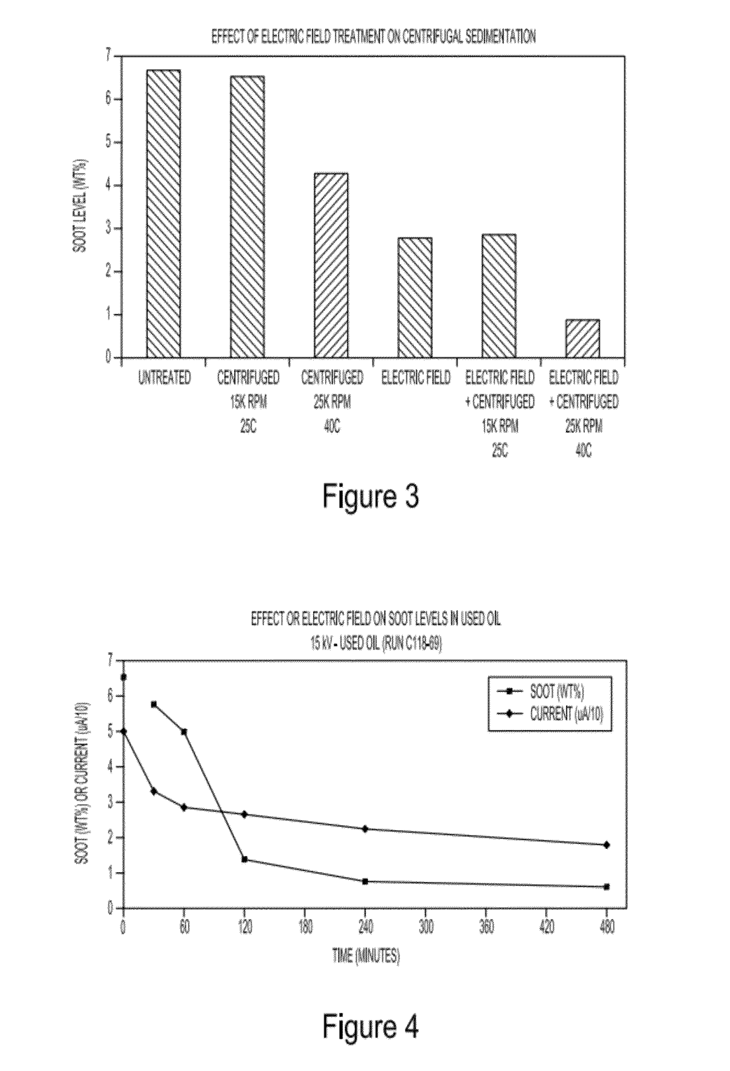

FIG. 3 illustrates the electro-agglomeration effect on centrifugal
sedimentation.

Electric field (DC) treatment had no effect on sedimentation rate at
15,000 RPM and 25 C.
Spinning hotter and faster showed at least 2X differentiation
Appears that the soot does ‘preagglomerate’ to some extent prior
to settling on electrode

### Electro-Agglomeration

### Example II

Change in Setup

Same power supply
Changed electrodes from 60 × 60 mesh screen, 1 cm × 5.2 cm
(w × l), spaced 1.5 cm apart to platinum gauze 0.8 cm × 1.9
cm, same spacing, with platinum wire terminals
This change will allow manual switching of current polarity for
frequencies other than 60 Hz

ATTORNEY-CLIENT COMMUNICATION and/or ATTORNEY WORK
PRODUCT Current

Power supply has built-in AC mode at 60 Hz
Lower frequency work will be done manually (cycles/minute)

Effect of time on centrifugal sedimentation rate

Previous work done at fixed 90 minutes exposure to current (15 kV)
0.5, 1.0 and 1.5 Hrs exposure to 15 kV using new setup

Electro-agglomeration- Effect on Soot Level
Power Supply

Hipotronics HD125 AC/DC Power Supply
25 kV/5 mA (adjustable) output current- set to 15 kV (DC)

Electrodes

60 × 60 mesh screen, 1 cm × 5.2 cm (w × l), spaced 1.5 cm apart

Oil

(~6.9 wt % soot)

PROTOCOL

Electrodes clamped vertically in 10 cc flask containing ~9.5 cc used
oil, no mixing
Applied 15 kV voltage and noted current decrease over time
0.25 cc samples removed at 0, 0.5, 1, 2, 4 and 8 hours for soot TGA
analysis

FIG. 4 illustrates the electro-agglomeration of soot vs. time for Example II. As shown, the soot levels decreased substantially over a period of several hours. Also, the agglomerated gel/paste on the electrode contained >24 wt % soot. Also, the soot concentrated by ˜4× in oil matrix and the current dropped off rapidly with build-up of the agglomerate on the positive electrode.

### Example III Electro-Agglomeration

### Effect on TBN

Power Supply

Hipotronics HD125 AC/DC Power Supply
25 kV/5 mA (adjustable) output current- set to 15 kV (DC)

Electrodes

60 × 60 mesh screen, 1 cm × 5.2 cm (w × l), spaced 1.5 cm apart

Oil

(~6.9 wt % soot)

PROTOCOL

Electrodes clamped vertically in 25 cc flask containing ~20 cc used
oil, no mixing
Applied 15 kV voltage and noted current decrease over time
0.75 cc samples removed at 0, 1, 2, 4 and 6.5 hours for TBN (D4739)

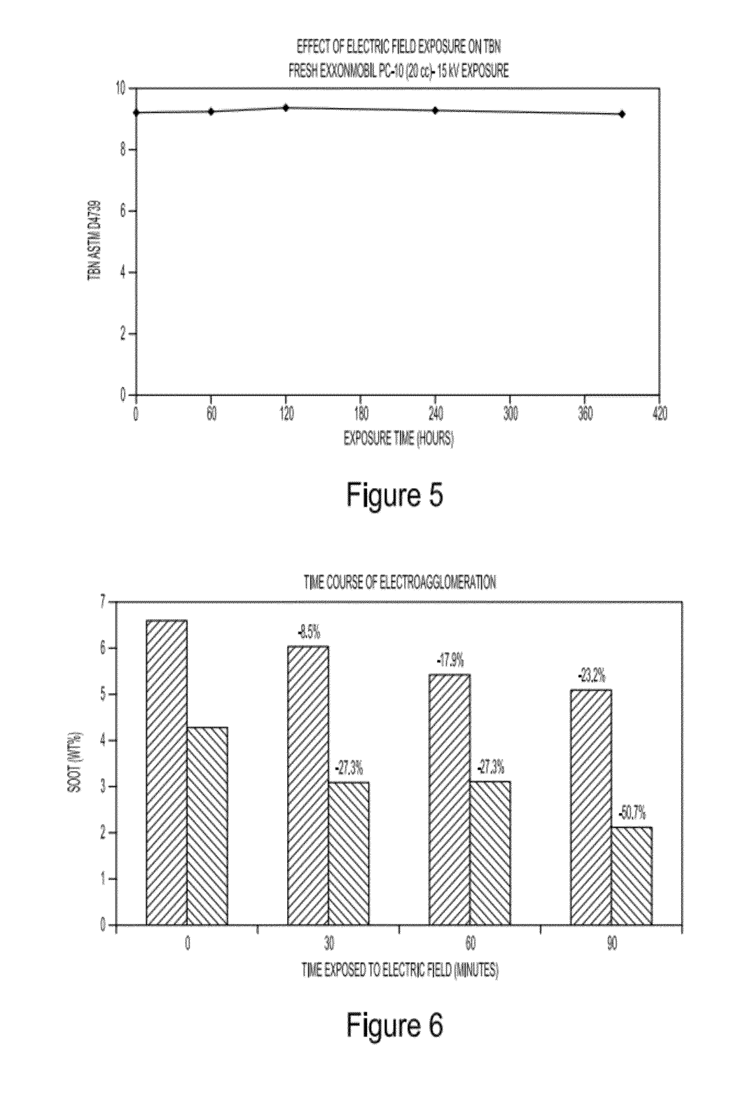

The effect of electro-agglomeration on TBN is illustrated in FIG. 5, and as shown, little measurable effect on TBN was observed.

### Example III

### Electro-Agglomeration—Effect on Centrifugal Sedimentation

Power Supply

Hipotronics HD125 AC/DC Power Supply
25 kV/5 mA (adjustable) output current- set to 15 kV (DC)

Electrodes

Platinum gauze 0.8 cm × 1.9 cm, spaced 1.5 cm apart

Oil

From engine test (~6.6 wt % soot)

PROTOCOL

Electrodes clamped vertically in 20 cc flask containing ~20 cc used
oil, no mixing
Applied 15 kV voltage for 30, 60 and 90 minutes
2 cc of electro-treated oil removed and centrifuged at 25,000 rpm,
40 C. for 1 hour
Soot by TGA performed on spun and unspun electro-treated oils and
control oil

FIG. 6 illustrates a time course of electro-agglomeration for Example III. Here the treatments are shown as follows: electric field only in lighter shade and electric field+centrifugation in darker shade. The values above each bar show percent reduction from respective time=0 control. At 90 minutes electric field treatment resulted in twice the soot reduction vs. 30 minutes.

### Example IV

### Electro-Agglomeration—Effect on Centrifugal Sedimentation

Power Supply

Hipotronics HD125 AC/DC Power Supply
25 kV/5 mA (adjustable) output current- set to 15 kV (DC)

Electrodes

60 × 60 mesh screen, 1 cm × 5.2 cm (w × l), spaced 1.5 cm apart

Oil

(~6.9 wt % soot)

PROTOCOL

Electrodes clamped vertically in 10 cc flask containing ~10 cc used
oil, no mixing
Applied 15 kV voltage for 90 minutes
3 g of electro-treated oil removed immediately and centrifuged
15,000 rpm at 25 C. for 1 hour

24,000 g, fluid column height ~1.1 inches

Soot by TGA performed on spun and unspun electro-treated oil and
control oil

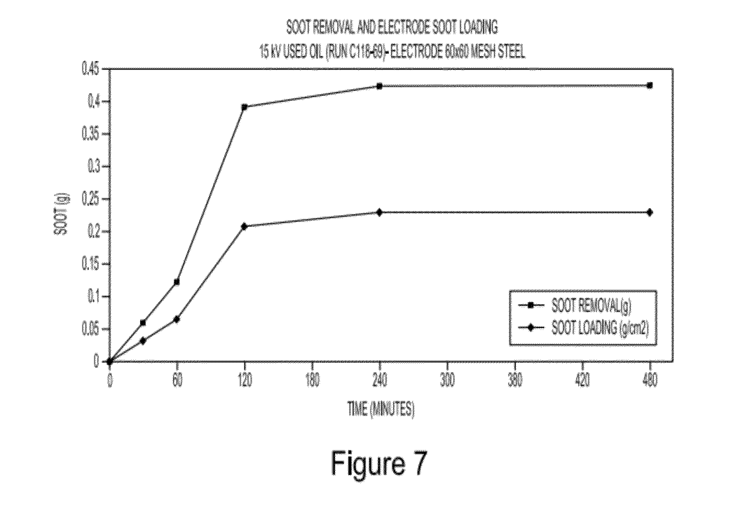

FIG. 7 illustrates how much electrode area would be required to reduce soot from 6.5 wt % soot to 2.5 wt % in 10 gallons of oil. 10 gal. oil=32173 g×0.04=1287 g soot and if we use 0.23 g/cm² as max soot loading, then you would need: 1287/0.23=5595 cm² electrode face area or this would be an electrode screen of about ˜75×75 cm.

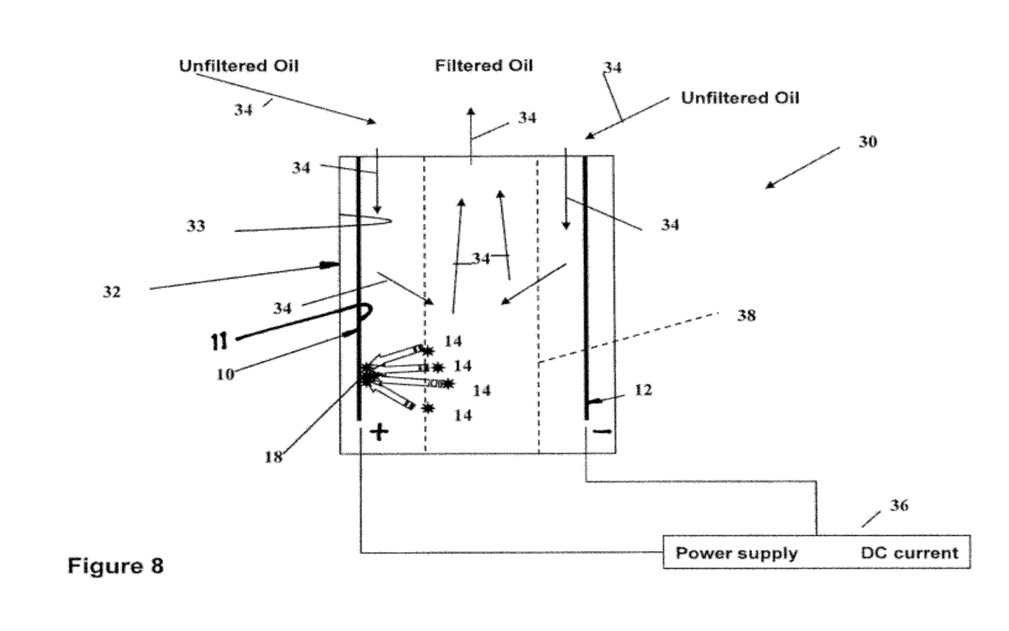

Referring in particular to FIG. 8 a non-limiting exemplary embodiment of the present invention is illustrated. Here a filter 30 for removing soot particles from an engine oil having soot particles disposed therein is illustrated schematically. The filter includes a housing 32 having an inlet and an outlet defining a flow path through a chamber 33 defined by the housing. The flow path is illustrated schematically by arrows 34 and it is, of course, understood that the filter may comprise constructions or configurations alternative to those shown in the attached Figures as the same are merely provided as an illustrative example namely, that the filter has at least one inlet opening to receive unfiltered oil and an oil outlet opening to release oil after it has passed through and/or by the pair of electrodes. As shown, the pair of electrodes 10 and 12 is electrically connected to a power supply 36. In accordance with an exemplary embodiment of the present invention and wherein an electrostatic field is generated by the pair of electrodes, soot particles 14 agglomerate into a mass or masses of soot particles 18 on the positive electrode as shown in FIG. 8. Here, to enhance the capability of the electrode a coating 11 is applied to the surface thereof, wherein the coating is a soot-collecting agent having properties and configured to improve the soot-collecting efficiency thereof.

In accordance with an exemplary embodiment of the present invention the coating 11 applied to the surface of the positive electrode may include as components, soot particles extracted from lubricating oil, carbon black from acetylene, soot purchased commercially, activated carbon powder, oil-absorbing polymer, other soot-collecting agents or a combination thereof. Here, the coating is adhered to the surface of the positive electrode using a suitable adhesive material or the like.

In accordance with an exemplary embodiment of the present invention the filter housing is configured to allow removal and replacement of at least the positive electrode. For example, the housing may comprise a removable cap to access the chamber. In one embodiment, the positive electrode is removable for cleaning and replacement or it is removed and discarded while a new positive electrode is inserted into the filter wherein the new positive electrode is easily coupled to the power supply. In one exemplary embodiment, the power supply is integral with the engine or system the oil filter is fluidly coupled to. Furthermore, the power supply can be easily connected and disconnected from the filter housing and/or the electrodes to allow removal and replacement of the filter and/or the positive electrode. In one exemplary embodiment, the filter and housing may be totally removed and replaced or the filter housing is integral with the engine and comprises a cap for access into the chamber of the housing, wherein the electrode(s) are removed. Also, and as discussed above, as the soot agglomerates on the positive electrode the current levels decrease. Measurement of the current via an amp meter may help to determine when to remove and replace the positive electrode namely, the observed current will indicate when the filter needs to be replaced.

In one alternative embodiment and for separation by filtration via a filter media only, this mechanism would likely require the use of alternating current in order to maintain agglomerates in the oil flow for downstream separation by centrifugation or filtration by a filter media. Alternatively, and with a DC current the filter media can be employed to capture soot particles not captured on the positive electrode.

In one alternative exemplary embodiment, and as illustrated by the dashed lines in FIG. 8, a mechanical filter element 38 is also disposed inside the filter housing in the flow path 34 of the oil and the mechanical filter element is configured to filter the engine oil prior to its flowing out of the filter 30. As will be discussed herein the mechanical filter element 38 may be disposed in the same housing 32 of the filter with the pair of electrodes 10, 12 or the mechanical filter element comprising the filter media may be in a separate housing in fluid communication with the housing containing the pair of electrodes. In either scenario the pair of electrodes 10, 12 will be disposed in the oil flow path 34 after the inlet opening but upstream of a filtration surface of the mechanical filter element. This placement will ensure that the larger sized agglomerated particles will be captured by the filter media or, in the alternative, a centrifuge device. Alternatively, only the positive electrode is disposed before an exterior filtration surface of the mechanical filter element. It is, of course, understood that the electrodes may comprise any arrangement as long as the desired affects of the electrical field are achieved. In accordance with an exemplary embodiment in order to remove the agglomerated soot particles at least the positive electrode is removable from the filter, wherein the positive electrode is either removed and replaced or cleaned and replaced. It is also understood that the other electrode may also be removable. Alternatively, the electrodes may be fixed in a removable filter comprising a housing removably secured to an oil circuit thus, they are not removable from the filter housing and simply accumulate soot on the positive electrode until the filter or filter housing comprising the electrodes needs to be replaced.

For example, and in one embodiment, the filter comprising the housing is a screw on type of filter wherein the entire housing comprising the electrodes is removed and replaced. Alternatively and when the housing is integral with the engine, the housing has a cap portion that is removed and the electrodes are simply removed and, if applicable, the filter media is also removed.

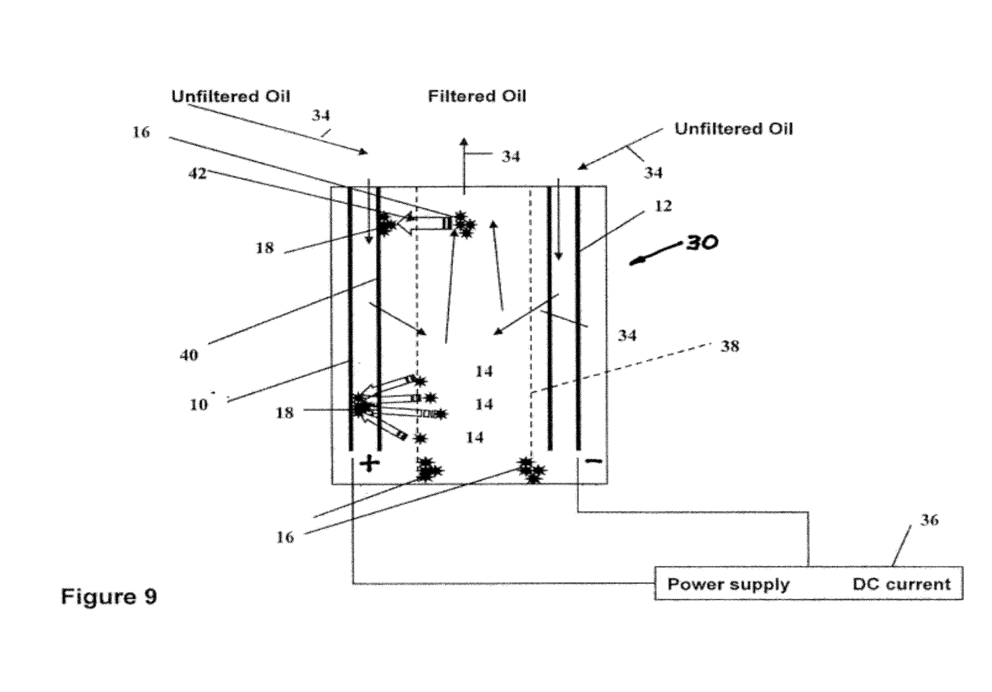

Referring in particular to FIG. 9 another non-limiting exemplary embodiment of the present invention is illustrated schematically. In accordance with an exemplary embodiment the electric field also causes the soot, sludge and other insoluble particulates from the oil to agglomerate resulting in a larger average particle diameter or size wherein these particles are removed by a filtering process, which may or may not include the removable positive electrode. In other words, the electrodes are used to increase the particle size and thereafter the enlarged particle is removed using other filtration techniques (e.g., centrifugal force or mechanical filtering).

In one alternative exemplary embodiment, and as illustrated by the dashed lines in FIG. 9, a mechanical filter element 38 is disposed inside the filter housing in the oil flow path 34 and it is configured to filter the engine oil prior to its exiting the filter 30.

In another alternative embodiment, also shown in FIG. 9, the filter further comprises a rotatable member 40 capable of applying a centrifugal force 42 to the oil 40 & 42. The centrifugal force causes the soot particles 14 to be disposed upon a surface of the rotatable member (e.g., a mesh screen or other filtration media), which is also removable from the filter to allow for removal of the particles. This filter may comprise the pair of electrodes, the filter media and the rotatable member or any combination thereof. In this embodiment, a motor or oil flow or both is used to apply a rotational force to a rotatable member to cause the centrifugal force to be applied to the oil.

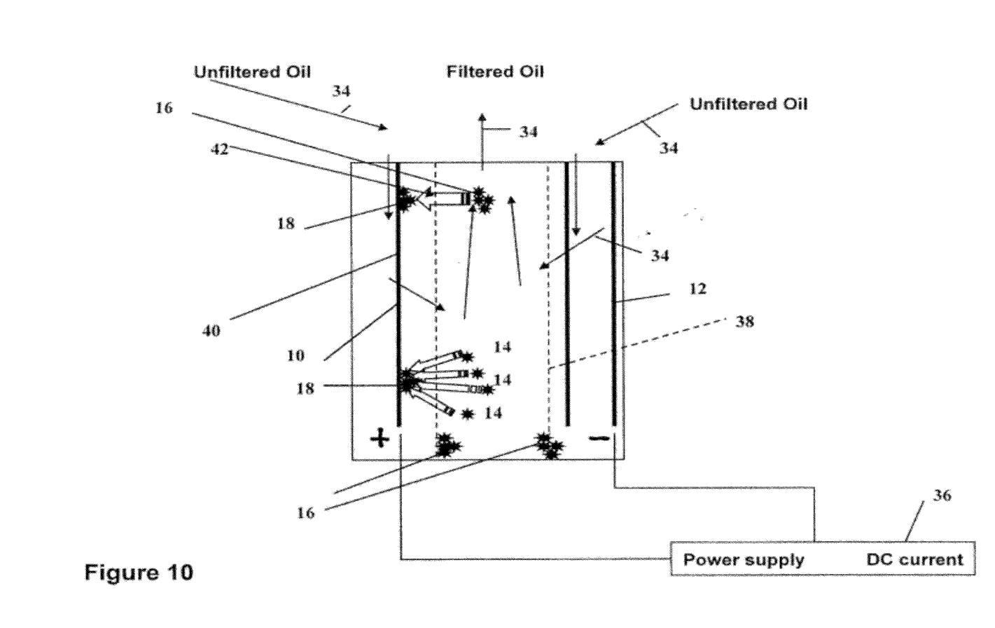

In one alternative exemplary embodiment, the electrode arrangements may include a metallic mesh serving as the positive electrode and may be formatted in a spiral wound, pleated, concentric or stacked plate arrangement. The positive electrode may also be in the form of a conducting fiber packed into a fixed-bed flow arrangement. Alternatively, the positive electrode may be formed of stainless steel, copper, aluminum, platinum or other electrically conducting material. In one exemplary embodiment of the present invention, the surface of the positive electrode has a coating applied, wherein the coating is a soot-collecting agent such as soot particles extracted from lubricating oil, carbon black from acetylene, soot purchased commercially, activated carbon powder, oil-absorbing polymer, other soot-collecting agents or a combination thereof configured to improve the soot-collecting efficiency on the surface of the positive electrode. In another alternative embodiment and referring to FIG. 10, the rotating element or member 40 in a centrifuge may also serve as the positive electrode, thus combining electrostatic with centrifugal separation in a single electro-mechanical device. Alternatively, the rotating element and the positive electrode are separate items.

In another embodiment, the filtering process is facilitated by filtering the larger diameter or size soot particles through a filtration media of the mechanical filter element, wherein the soot particles are disposed upon a surface of the filtration media. The filtration media being any media capable of providing the desired results (e.g., cellulose, nylon, synthetic or equivalents thereof).

Also illustrated in FIG. 10 is a pair of electrodes that are disposed in the flow path, the electrodes being disposed in the flow path after the inlet but before an exterior filtration surface of the mechanical filter element 38. In accordance with an exemplary embodiment, the pair of electrodes are electrically coupled to an electric current, wherein an electric field is generated by the pair of electrodes. One of the pair of electrodes is a positive electrode and the electric field causes a portion of the soot particles to agglomerate on the positive electrode. Here, a coating is applied to the surface of the positive electrode, wherein the coating is a soot-collecting agent configured to improve the soot-collecting efficiency on the surface of the positive electrode. In order to remove the agglomerated soot particles at least the positive electrode is removable from the filter, wherein the positive electrode is either removed and replace or cleaned and replaced. It is also understood that the other electrode may also be removable.

In accordance with an exemplary embodiment, the filter may comprise only the pair of electrodes with at least one removable electrode. Alternatively, the filter will comprise the pair of electrodes and a filtration media configured to filter the larger diameter preagglomerated soot particles. In yet another alternative embodiment, the filter will comprise the pair of electrodes and a rotatable element for applying a centrifugal force to the preagglomerated soot particles and a removable surface for collecting the preagglomerated soot particles. In yet another alternative exemplary embodiment, the rotating element and the positive electrode are combined or are one in the same. In still yet another alternative embodiment, the filter will comprise the pair of electrodes, a filtration media configured to filter the larger diameter preagglomerated soot particles and a rotatable element for applying a centrifugal force to the preagglomerated soot particles having a removable surface for collecting the preagglomerated soot particles.

In accordance with an exemplary embodiment, the lubricating oil containing soot is allowed to flow between two electrodes connected to an electric current. Upon application of an electric current, the soot will collect on the positive electrode to very high levels under certain conditions and electrode arrangements. The electrode arrangements may include a metallic mesh serving as the positive electrode and may be formatted in a spiral wound, pleated, concentric or stacked plate arrangement. The positive electrode might also be in the form of a conducting fiber packed into a fixed-bed flow arrangement. Alternatively, the positive electrode may be formed of stainless steel, copper, aluminum, platinum or other electrically conducting material. In one exemplary embodiment of the present invention, the surface of the positive electrode has a coating applied, wherein the coating is a soot-collecting agent such as soot particles extracted from lubricating oil, carbon black from acetylene, soot purchased commercially, activated carbon powder, oil-absorbing polymer, other soot-collecting agents or a combination thereof configured to improve the soot-collecting efficiency on the surface of the positive electrode. The rotating element in a centrifuge may also serve as the positive electrode, thus combining electrostatic with centrifugal separation in a single electro-mechanical device. The oil flow to the soot removal device may be either a full flow or bypass flow with or without further downstream separation.

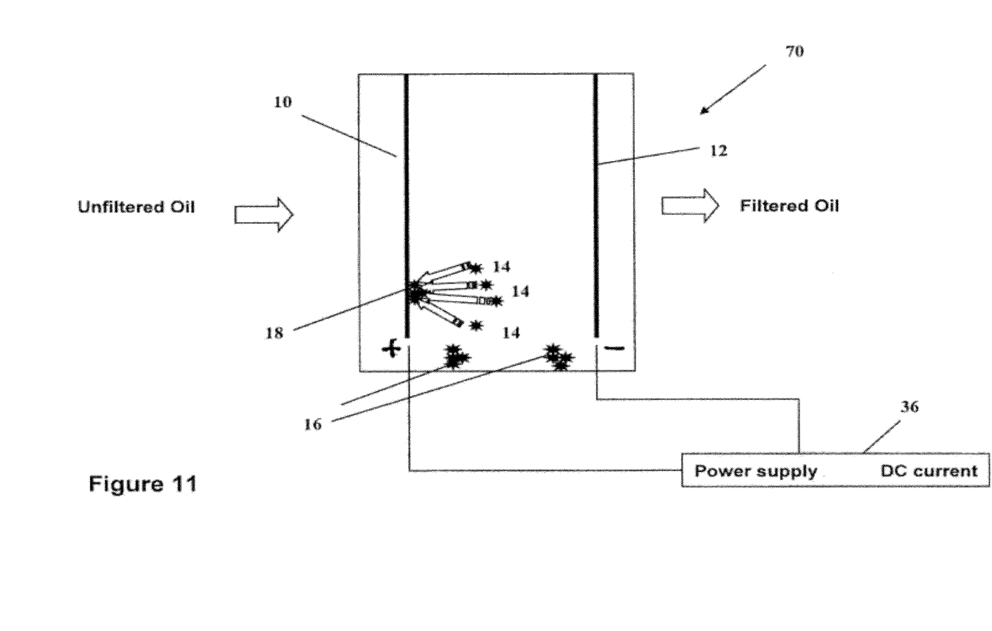

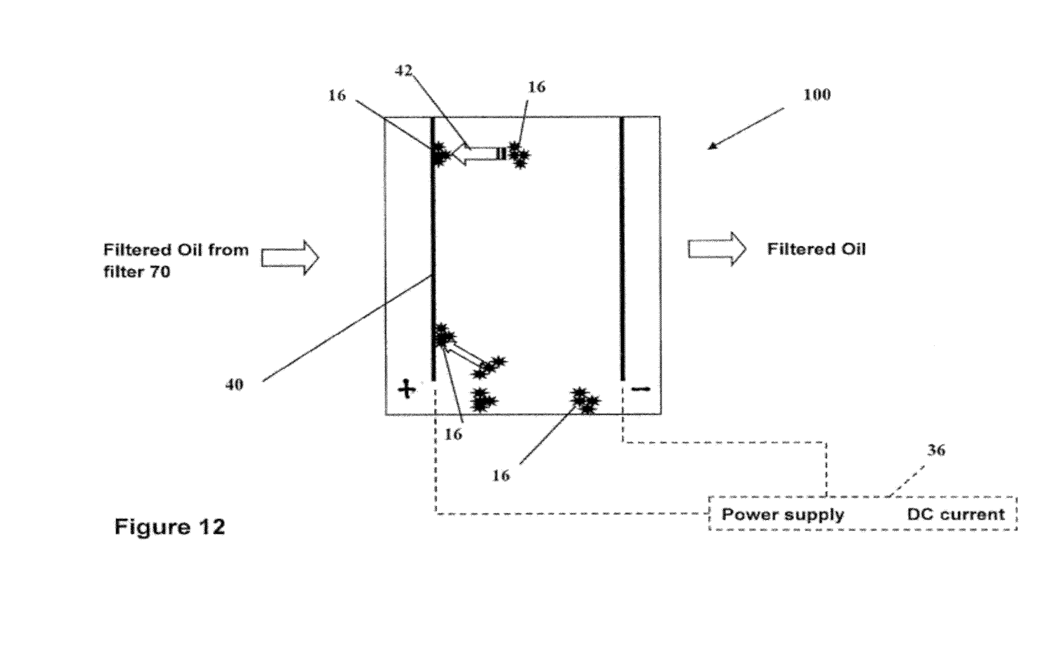

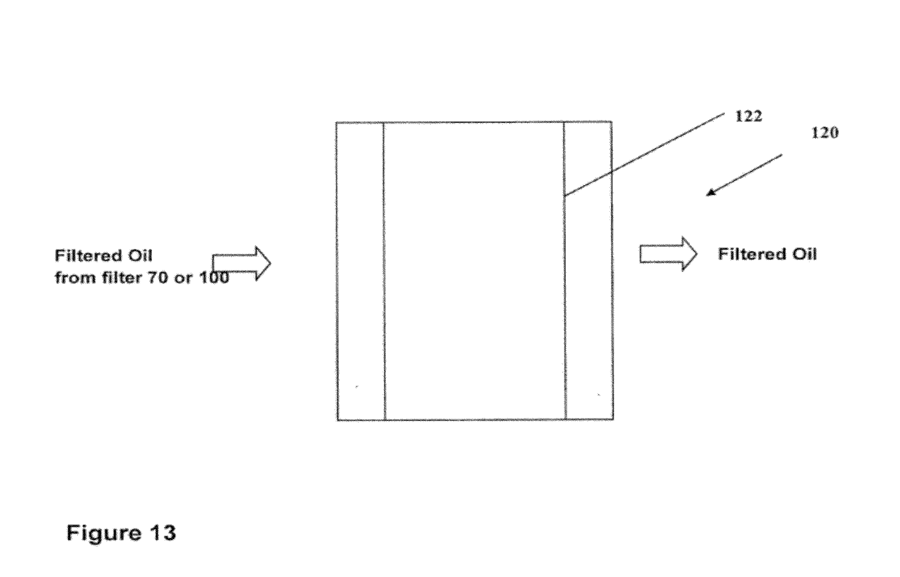

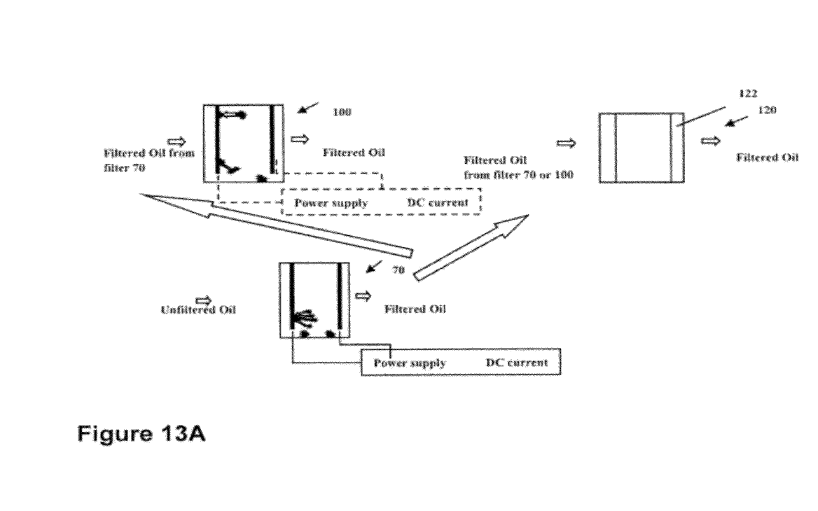

For example, and as illustrated in FIGS. 11-13A a system of filters may be employed. As illustrated in FIG. 11 a filter 70 may only comprise the pair of electrodes wherein the unfiltered oil is passed between the electrodes and soot is agglomerated on the positive electrode and then the filtered oil of filter 70 is transferred to another filter 100 (FIG. 12) having a centrifuge 40 (with or without a pair of electrodes) to further separate the pre-agglomerated oil and thereafter, or as an alternative to the filter of FIG. 12 a filter 120 having filter media 122 disposed in a filter housing is provided as illustrated in FIG. 13. Thus, a system (FIG. 13A) comprising a first filter 70 (FIG. 11), a second filter 100 (FIG. 12) and a third filter 120 (FIG. 13) may be provided. It being understood that the arrows in at least FIGS. 11-13A represent fluid flow of an oil between each of the filters, wherein the fluid flow is facilitated by a conduit or other means for transferring the oil into and out of the filter.

In accordance with an exemplary embodiment of the present invention the filters may be connected in series or alone as stand alone filters, wherein each of the filters are in fluid communication with each other via an oil circulation system. For example, the system may comprise only one filter (FIG. 11 or 12) or any combinations of the filters illustrated in FIGS. 11-13. The filters may also comprise a bypass filter of the system wherein only a portion of the oil is passed therethrough.

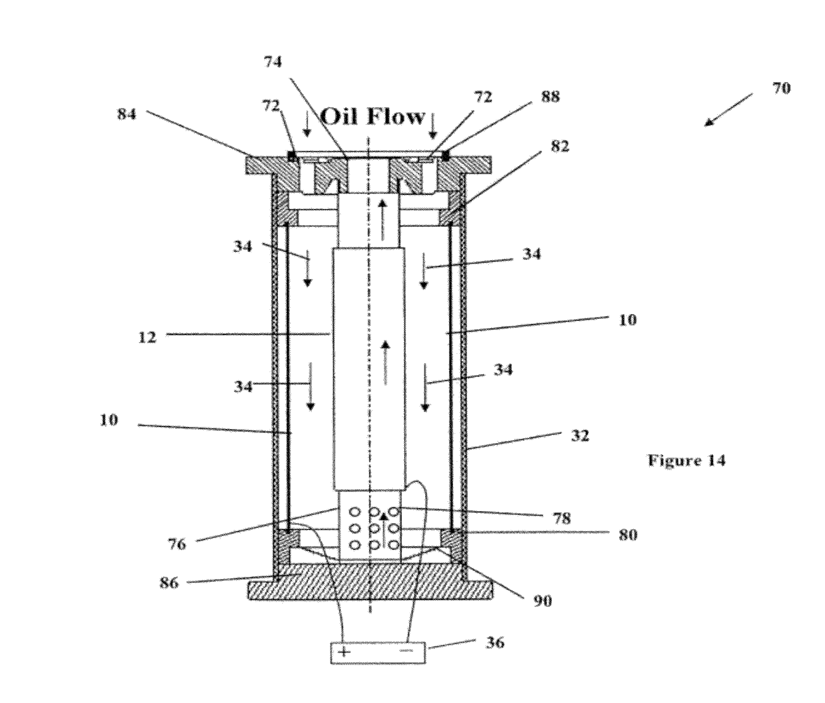

FIG. 14 illustrates one non-limiting exemplary embodiment of a filter 70 (e.g., a filter having a pair of electrodes disposed therein). Here filter 70 has a plurality of inlet openings 72 and at least one outlet opening 74. In this embodiment, a center tube 76 defines the at least one outlet opening wherein the oil flow through filter 70 is illustrated by arrows 34. As illustrated, a bottom portion 78 of the center tube has openings to facilitate the oil flow therethrough. In this embodiment, the negative electrode 12 is disposed about the center tube and the positive electrode 10 disposed in a facing spaced relationship with respect to the negative electrode 12. In this embodiment, the negative and positive electrodes comprise closed loops (e.g., circle, oval or other equivalent structures) of electrically conductive materials. In one non-limiting exemplary embodiment, the eclectically conductive materials are wire mesh screens or at least the positive electrode is a wire mesh screen to facilitate oil flow therethrough. The oil filter 70 also has a top end disk 80 and a bottom end disk 82 the bottom end disk being proximate to a tapping plate 84 having the inlet and outlet openings. The top end disk is disposed proximate to a top plate 86 disposed at an opposite end of the housing. The filter 70 further includes a seal 88 (e.g., rubber, elastomeric or other equivalent type of material) located on the tapping plate to fluidly seal the tapping plate to a portion of an oil circulation system that the filter is in fluid communication with. A retainer 90 secures the center tube to the top end disk and the top plate. As discussed herein, the pair of electrodes of the oil filter 70 are electrically coupled to a power supply 36. Exemplary embodiments contemplate a filter having a removable top plate wherein the positive electrode is able to be removed and replaced when the positive electrode has accumulated oil soot thereon. In one embodiment, the positive electrode is simply removed, cleaned and replaced or the electrode is simply discarded and a new electrode is inserted into the filter by engaging the bottom end disk and the top end disk, retainer and the top plate are replaced on the filter housing. Alternatively, the oil filter is simply discarded wherein clean or new electrodes are provided in the new filter.

In any of these embodiments, the power supply is removably secured to the oil filter to allow removal and replacement of the oil filter wherein the filter itself is simply replaced or the electrodes of the filter are replaced. In one exemplary embodiment, the power supply is electrically coupled to a power supply of a vehicle having an engine with the oil system requiring filtration.

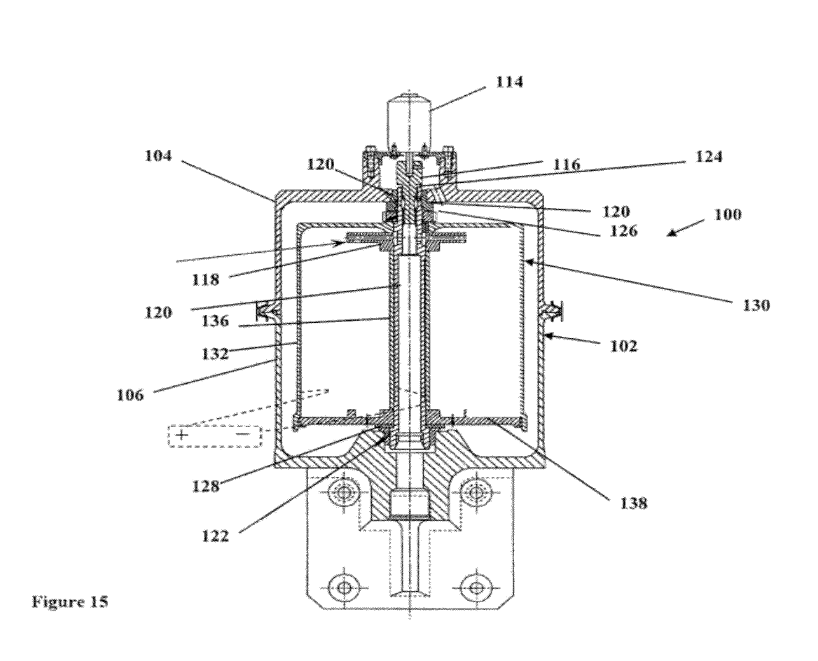

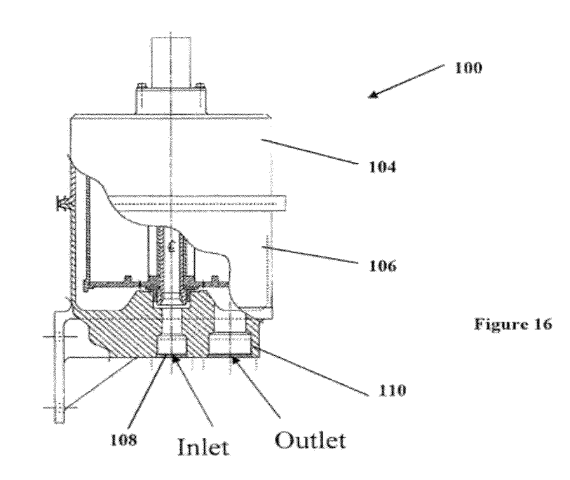

FIGS. 15 and 16 illustrate a non-limiting configuration of a filter 100 constructed in accordance with an exemplary embodiment of the present invention. Here filter 100 has a housing 102 with an upper housing portion 104 and a lower housing portion 106. The housing having an oil inlet 108 and an oil outlet 110 and a means 112 (e.g., motor 114, shaft 116, flow induced rotor 118, an upper bearing 120, a lower bearing 122, an O-ring packing 124, a rotor nut 126 and a washer 128) for rotating a centrifuge rotor 130 having an outer wall 132, a sleeve 136 and a lower exit rotor 138 for providing a centrifugal force to oil passing through filter 100. The upper or lower housing of the filter 100 is removable to allow removal and replacement of the centrifuge when the centrifuge has accumulated oil soot thereon. In one embodiment, the centrifuge rotor 130 is simply removed, cleaned and replaced or the centrifuge rotor 130 is simply discarded and a new centrifuge rotor is inserted into the filter. In one exemplary embodiment, the centrifuge rotor 130 may comprise a closed annulus (e.g., circle, oval or other equivalent structures) of electrically conductive materials. In one non-limiting exemplary embodiment, the electrically conductive materials are wire mesh screens or at least the positive electrode is a wire mesh screen. In yet another non-limiting exemplary embodiment, the positive electrode may be formed of stainless steel, copper, aluminum, platinum or other electrically conducting material. Alternatively; the centrifuge rotor 130 may comprise a closed annulus (e.g., circle, oval or other equivalent structures) of non-conductive materials. Of course, other configurations are considered to be within the scope of exemplary embodiments of the present invention. Alternatively, the oil filter is simply discarded wherein clean or new centrifuge rotors are provided in the new filter.

One non-limiting example of a filter similar to filter 100 is found in U.S. patent application Ser. No. 11/626,476 filed Jan. 24, 2007, the contents of which are incorporated herein by reference thereto. It being understood that this filter may be in series with other filters (e.g., filter 70 and filter 120) wherein each of the filters are in fluid communication with an oil or the components of filter 100 can be incorporated into a filter having a pair of electrodes and in one alternative one of the electrodes may comprise a portion of the centrifuge of the filter. For example, and as illustrated by the dashed lines in FIG. 15 a power supply may be electrically coupled to the filter, wherein the centrifuge becomes the positive electrode and the sleeve or shaft becomes the negative electrode.

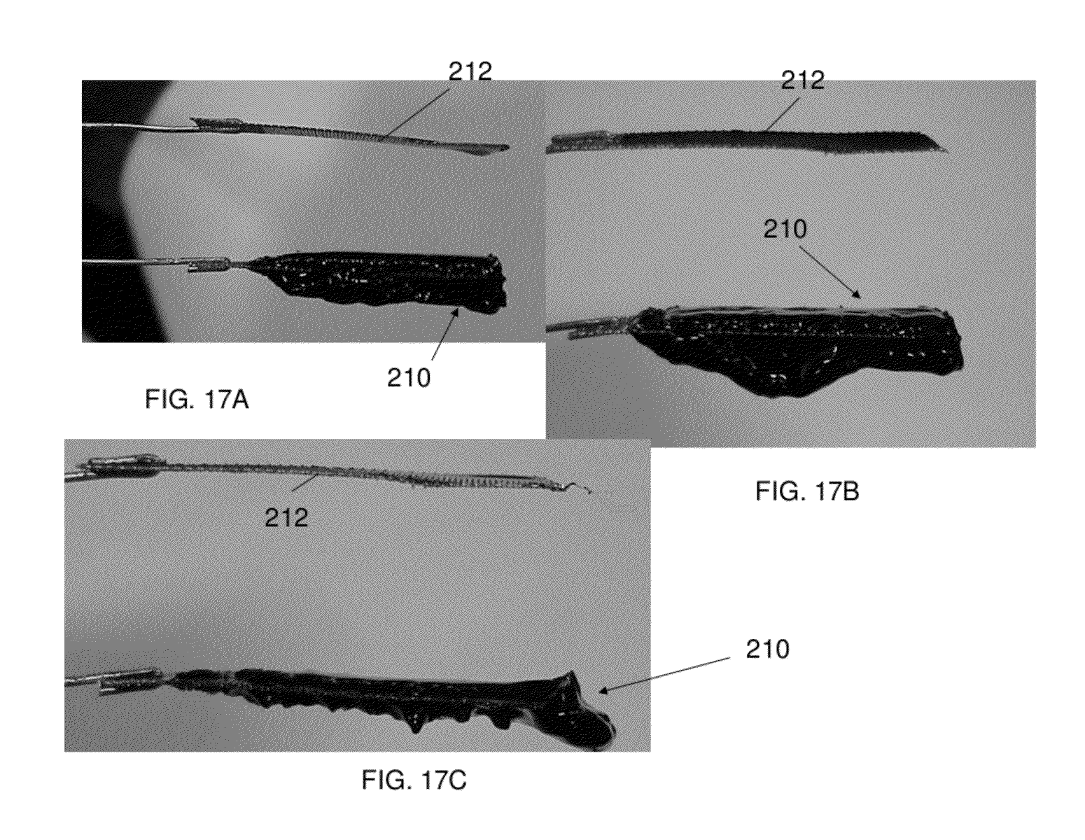

Referring now to FIGS. 17-21 and as discussed above, soot accumulation in diesel engine lubrication oil adversely affects the oil properties by increasing the oil viscosity and reducing the wear prevention characteristics. This prevents the fleet owners from extending the oil drain intervals thus increasing their maintenance expenses. Exemplary embodiments disclosed herein facilitate efficient removal of soot and consequently the extension of oil drain interval for transportation and static applications.

Accordingly, the soot removal helps maintain the oil viscosity for an extended period of time and improves the wear characteristics of the oil. Current technologies with soot removal efficiencies of less than 20% do not provide an efficient enough soot removal solution to generate any significant extension of the oil drain intervals for the fleets.

FIGS. 17A-17C illustrate a pair of electrodes 210 and 212 for generating the electric field for use in the electro-agglomeration process, wherein electrode 210 is the soot collecting electrode for example, the positive electrode. The electrodes are constructed out of mesh material, which may be stainless steel, copper, aluminum, platinum or other electrically conducting materials. The electrodes are then electrically attached to a power supply.

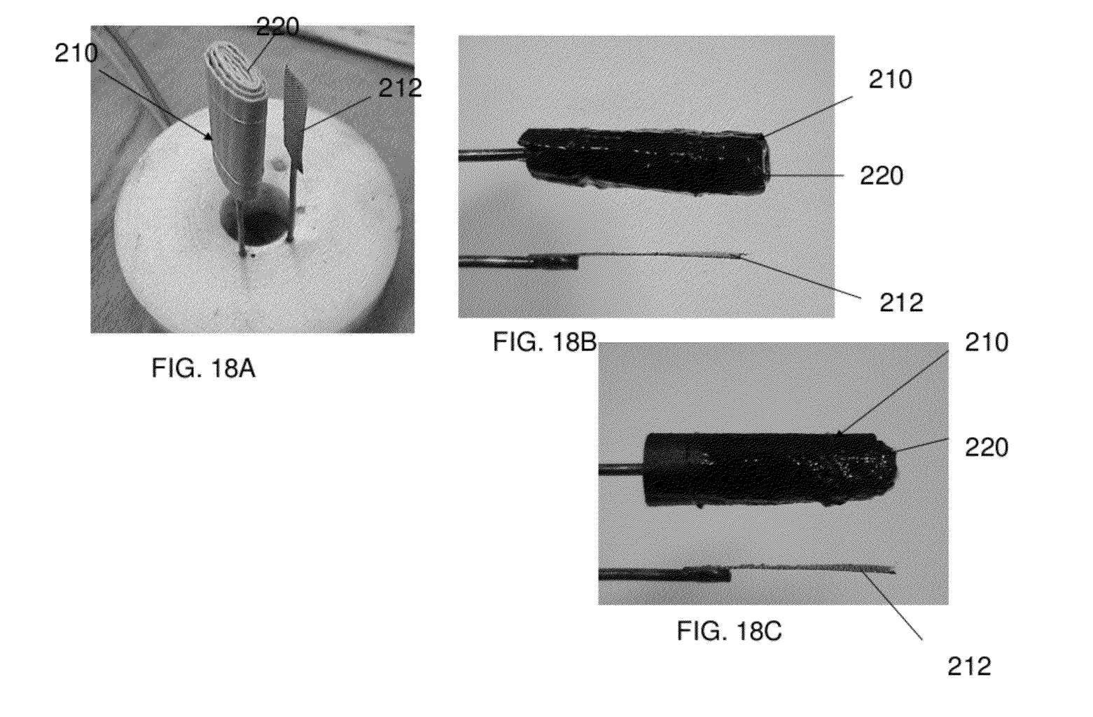

Referring now to FIGS. 18A-18C, one of the two electrodes for generating the electric field is wrapped with a media 220 to remove the soot particles from the oil. In an exemplary embodiment, the soot collecting electrode 210 is covered with the media. The media 220 provides additional structural support for the soot as it is accumulated on the soot collecting electrode. The media may comprise a single layer of media wrapped around the collecting electrode or a plurality of layers of media wrapped around the soot collecting electrode. FIG. 18A illustrates the electrode 210 prior to the soot collection process and FIGS. 18B and 18C illustrate the electrodes after the soot collection process. In addition and in various embodiments, the voltages uses to generate the electric fields were varied and lower voltages also provided desirable results. In still another alternative embodiment, the electrode wrapped with the media may also be coated as discussed above with a soot-collecting agent that has properties to improve the collecting efficiency of the agglomerated soot or other particles on the positive electrode. Of course, wrapped electrodes without coatings thereon are also considered to be with the scope of the various embodiments of the disclosed herein.

In this embodiment an electric field is provided between two electrodes, one of which is wrapped by a media, which in one embodiment will comprise multiple layers of media to remove soot particles from the lubrication oil. Non-limiting examples of suitable media include but are not limited to the following examples: 1) woven and nonwoven fibrous materials, comprising any one of the following or combinations thereof organic fibers, natural or synthetic fibers made from cellulose, polyolefins, polyesters, polyamides; inorganic fibers, metallic and ceramic fibers, stainless steel fibers, alumina and spun glass and silica fibers; 2) open cell organic and inorganic foams made from polyurethanes, polyolefins, polyesters, polyamides; sintered ceramics, alumina or silica; and combinations thereof; and 3) electrodes mechanically surrounded by fine particles (particles kept within a cage or a screen which provides the voids) and fine particles of alumina, silica etc.

Accordingly, the soot particles agglomerate due to the generated electric field and move towards the media covered electrode. The wrapped media provides a structural support for the soot to grab onto and prevents the soot from sliding down the electrodes. The soot collection in one embodiment will mostly be in the media rather than on the media surface.

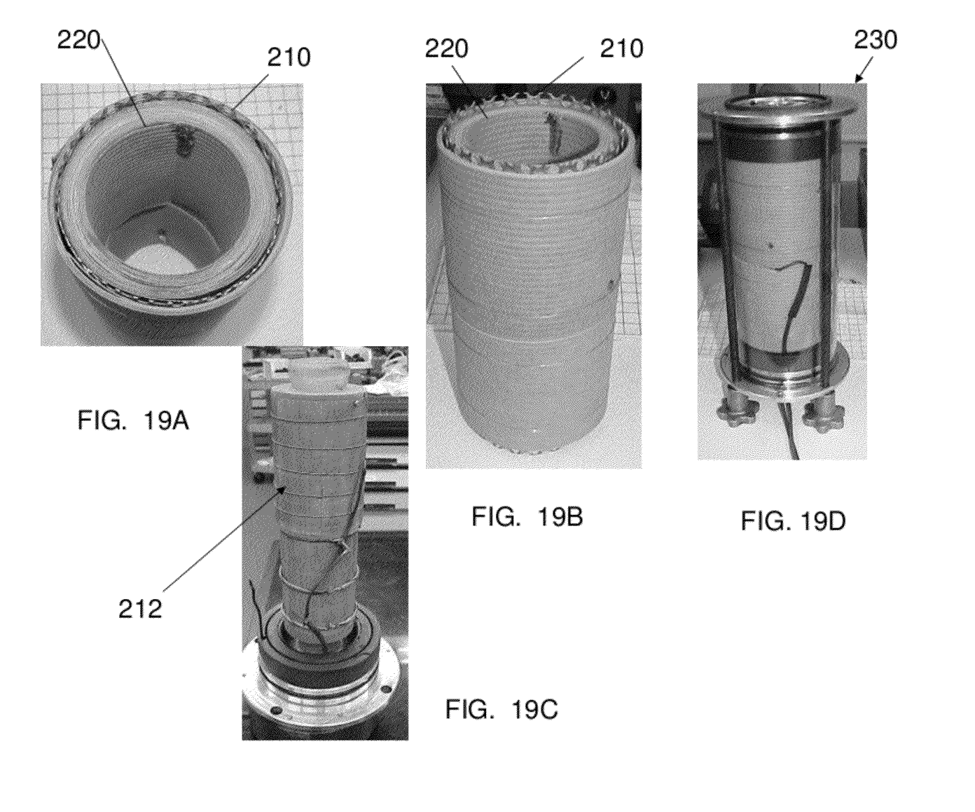

In one implementation the lubrication oil is flowed through the filter between two electrodes one of which is wrapped with the filter media. The electrode configuration could be two concentric cylinders (See at least FIGS. 19A-19D) arranged in a facing spaced relationship such that the appropriate electric field can be generated therebetween due to the applied voltage. Once again, at least one of the electrodes 210 can be covered with a media 220 and/or a soot-collecting agent. Of course, numerous other alternate configurations are contemplated. For example, the electrodes may be planar in shape and may be vertically arranged with respect to the orientation of the filter or alternatively, the electrodes may be horizontally arranged with respect to the filter. In one embodiment, the soot collecting electrode is positioned above the other electrode. Alternatively, the soot collecting electrode may be positioned below the other electrode.

FIGS. 19A-19B illustrate media 220 wrapped on a cylindrically configured electrode 210. FIG. 19C illustrates a filter arrangement 230 with a pair of concentrically arranged electrodes. As will be illustrated below numerous trials were performed to demonstrate the soot collecting efficiency of the various embodiments of the present invention. In one embodiment, a voltage of up to 10 kV is applied to the electrodes. Upon application of the current between the electrodes the soot will start migrating and collecting in the layers of media wrapped around the soot gathering electrode. The media 220 provides a strong structural support for the soot which otherwise may settle loosely on the electrode.

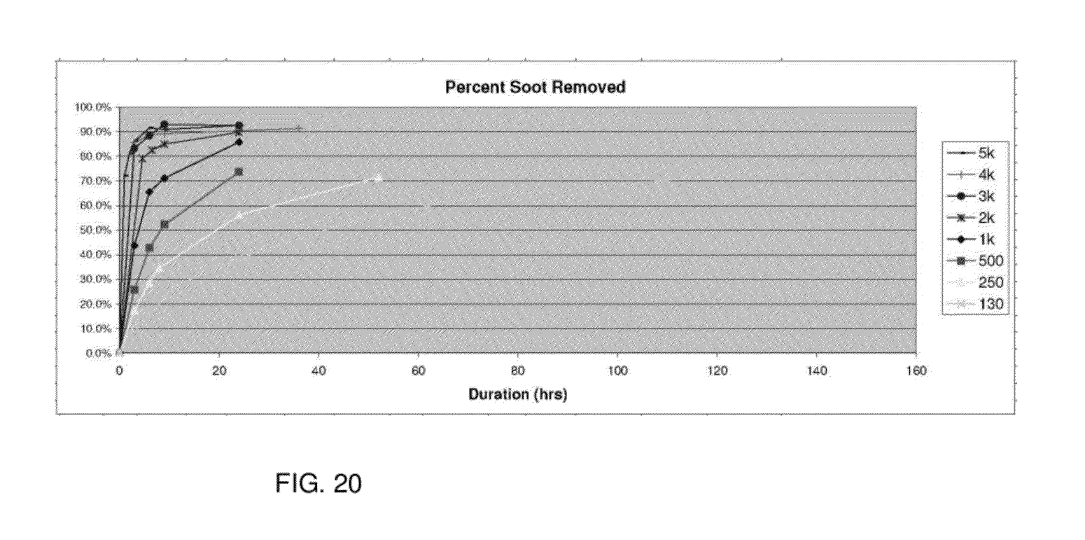

Once the media is saturated with soot the cartridge consisting of the media wrapped soot gathering electrode can be replaced with a new one. Alternatively, the media may be left in the filter provided that the media has enough capacity to entrain the soot particles therein. The graphs of FIGS. 20-25 as well as the below tables illustrate examples and data of still other exemplary embodiments of the present invention.

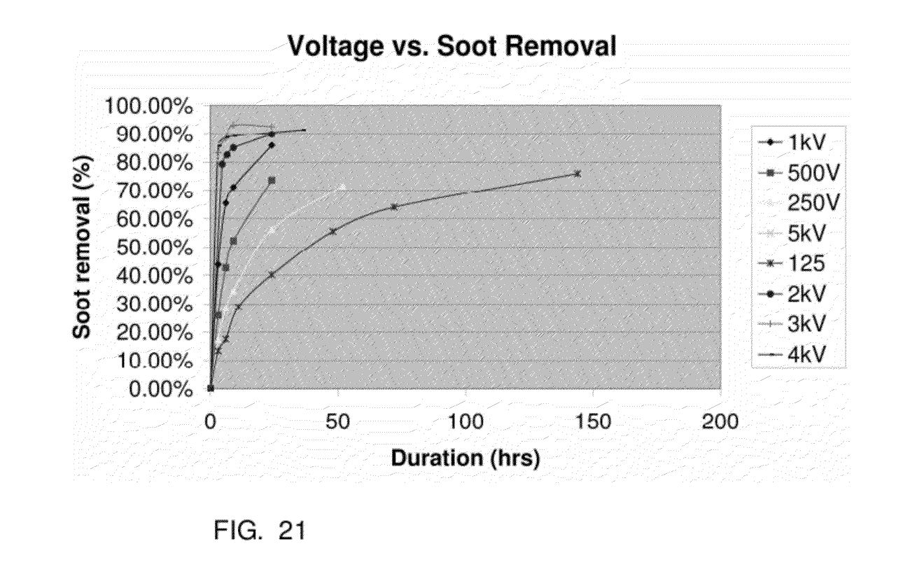

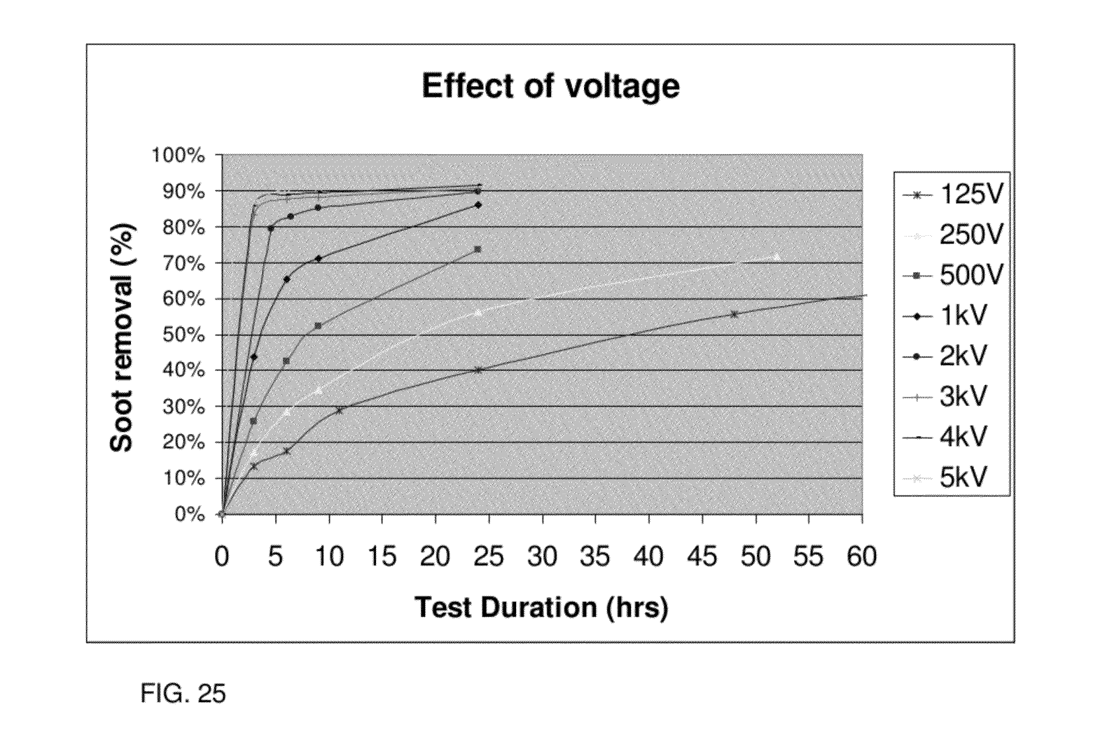

In one embodiment the intensity of the electric field is varied. For example and as illustrated in at least FIG. 25 over 70% soot removal was achieved with a voltage of 500V. FIG. 21 also illustrates various soot removal percentages at different voltages. As illustrated, a lower strength electric field between the two electrodes or materials which can generate an electric field is used. As such, a smaller power supply can be used. Once again, the soot particles agglomerate and move toward the electrode. The electrodes may or may not be wrapped with media. In addition, the electric field can be generated by an external power source or developed in-situ.

As discussed above, the lubrication oil is flowed through the filter between the two electrodes one of which may be wrapped with the filter media. The electrode configuration could be two concentric cylinders or other alternate configuration and the electrode distances can be reduced as compared to applications with stronger electric fields. The low strength electric field is generated either using an external power (lower than 3 kV) source or by developing in-situ using piezoelectric materials or other alternatives.

Upon application of the electric field the soot will start migrating and collecting around the soot gathering electrode. If media is used, the media will have to be replaced once it saturated with soot. Alternatively, both the soot collecting electrode and the media are removed and replaced.

In summary, there are at least several components to the soot removal process 1) generation of the electric field; 2) configuration of the electrically charged materials; and 3) stabilization of the debris cake.

Various ways may be employed to develop the electric field, which include but are not limited to the following methods/concepts: use of metallic electrodes within the oil's flow path which are connected to an external power supply; configuring piezoelectric materials into a flow path whereby the charge can be developed on the surface of the material by the cyclic pressure change developed during the course of filter's operation; use of thermoelectric materials which develop an electrical potential when brought up to a specified temperature; use of material partners which develop a triboelectric charge when these opposite materials (on the triboelectric scale) move or rub against each other against each other; and use of permanently charged materials, like fibrous materials, which have been previously charged through such processes like corona discharge, commonly called electrets.

The configuration of the electrically charged materials may be achieved by the following non-limiting methods and/or concepts: two electrodes or materials which possess/generate the electric charge are brought into close proximity so that the distance for migration is small in comparison to the mean free path of the suspended particles for example, electrodes parallel to the flow or perpendicular to the flow and wherein the collection zone and the electric field is perpendicular to the flow or the collection zone is within the flow past the non collection electrode so to speak parallel to the flow; and having the electrified materials in a woven or nonwoven format or a solid structure.

The stabilization of the debris cake may be achieved in one non-limiting manner by stabilizing the collected gel debris cake from the competing dissolution process by incorporating a porous media to provide static zones that can stabilize the collected cake. This concept may have more relevance when working with lower voltages and hence lower driving force configurations. Here the electrode(s) are surrounded by a porous material, either an open cell foam, fibrous woven or nonwoven material or any structure which can provide a tortuous continuous path to the electrode, wherein the size of the pores are sufficient to allow for unimpeded electrical migrational diffusion but small enough to prevent turbulence and dissolution of the gel cake.

In addition, this embodiment and others disclosed herein are also contemplated for use in gasoline passenger car applications to remove particulate debris from the lube oil including fine inorganic dust and sludge components resulting in an extension of the oil change interval.

The below Tables illustrate various trials utilizing the soot removal techniques and apparatus for various embodiments disclosed herein.

TABLE I
The data from Table I was used to create the graph illustrated in FIG. 20.

| | | | | | | | | | Sooty Oil/ | | | | | | Cur- | |
|---|---|---|---|---|---|---|---|---|---|---|---|---|---|---|---|---|
| Trial | | | | | | Fram | | Set % | Ttl | | Sample | TGA | | Duration | rent | % Soot |
| No. | Date | Temp | Pics | Volt | Space | No. | Diluent | Soot | Mix (g) | | ID | File | Soot | (hrs) | (mA) | removed |
| 1 | 4/15 | 202 | 1 | 1k | 1.5 cm | 25 + 26 + | Delvac | 2% | 7.29 | 24 | c | [symbol] ot1.074 | 2.06% | 0 | 0.0 | 0.0% |
| | | | 2 | | | 27 | | | | | d | [symbol] ot1.077 | 1.16% | 3 | 0.0 | 43.8% |
| | | | 3 | | | | | | | | e | [symbol] ot1.080 | 0.71% | 6 | 0.0 | 65.5% |
| | | | | | | | | | | | f | [symbol] ot1.081 | 0.59% | 9 | 0.0 | 71.2% |
| | 4/16 | | 4, 5 | | | | | | | | g | [symbol] ot1.082 | 0.29% | 24 | 0.0 | 85.9% |

Decreased the voltage

| | | | | | | | | | | | | | | | | |
|---|---|---|---|---|---|---|---|---|---|---|---|---|---|---|---|---|
| 2 | 4/16 | | | 500 | 1.5 cm | 25 + 26 + | Delvac | 2% | 7.29 | 24 | k | [symbol] ot1.083 | 2.07% | 0 | 0.0 | 0.0% |
| | | | | | | 27 | | | | | l | [symbol] ot1.084 | 1.54% | 3 | 0.0 | 25.9% |
| | | | 6, 7 | | | | | | | | m | [symbol] ot1.085 | 1.19% | 6 | 0.0 | 42.7% |
| | | | | | | | | | | | n | [symbol] ot1.086 | 0.99% | 9 | 0.0 | 52.3% |
| | 4/17 | 202 | | | | | | | | | o | [symbol] ot1.087 | 0.55% | 24 | 0.0 | 73.7% |

Decreased the voltage

| | | | | | | | | | | | | | | | | |
|---|---|---|---|---|---|---|---|---|---|---|---|---|---|---|---|---|
| 3 | 4/17 | 202 | 8, 9 | 250 | 1.5 cm | 25 + 26 + | Delvac | 2% | 7.29 | 24 | p | [symbol] ot1.088 | 2.11% | 0 | 0.0 | 0.0% |
| | | | 10, 11 | | | 27 | | | | | q | [symbol] ot1.089 | 1.74% | 3 | 0.0 | 17.4% |
| | | | 12, 13 | | | | | | | | r | [symbol] ot1.090 | 1.51% | 6 | 0.0 | 28.5% |
| | | | | | | | | | | | s | [symbol] ot1.091 | 1.38% | 8 | 0.0 | 34.6% |
| | 4/18 | | | | | | | | | | t | [symbol] ot1.092 | 0.92% | 24 | 0.0 | 56.2% |
| | 4/19 | | | | | | | | | | u | [symbol] ot1.093 | 0.60% | 52 | 0.0 | 71.6% |

Decreased the voltage

| | | | | | | | | | | | | | | | | |
|---|---|---|---|---|---|---|---|---|---|---|---|---|---|---|---|---|
| 4 | 4/21 | 205 | 14 | 130 | 1.5 cm | 25 + 26 + | Delvac | 2% | 7.29 | 24 | v | [symbol] ot1.106 | 2.06% | 0 | 0.0 | 0.0% |
| | | | | | | 27 | | | | | w | [symbol] ot1.107 | 1.83% | 3 | 0.0 | 11.2% |
| | | | | | | | | | | | x | [symbol] ot1.108 | 1.74% | 6 | 0.0 | 15.5% |
| | | | | | | | | | | | y | [symbol] ot1.112 | 1.50% | 11 | 0.0 | 27.1% |
| | 4/22 | | | | | | | | | | z | [symbol] ot1.111 | 1.26% | 24 | 0.0 | 38.7% |
| | 4/23 | | | | | | | | | | a | [symbol] ot1.123 | 0.94% | 48 | 0.0 | 54.5% |
| | 4/24 | | | | | | | | | | b | [symbol] ot1.125 | 0.74% | 72 | 0.0 | 64.0% |
| | 4/27 | | 15 | | | | | | | | c | [symbol] ot2.049 | 0.49% | 144 | 0.0 | 76.0% |

Increased the voltage

| | | | | | | | | | | | | | | | | |
|---|---|---|---|---|---|---|---|---|---|---|---|---|---|---|---|---|
| 5 | 4/29 | | 16 | 2k | 1.5 cm | 25 + 26 + | Delvac | 2% | 7.29 | 24 | d | [symbol] ot1.157 | 2.07% | 0 | 0.0 | 0.0% |
| | | | | | | 27 | | | | | e | [symbol] ot1.158 | 0.43% | 4.6 | 0.0 | 79.2% |
| | | | | | | | | | | | f | [symbol] ot1.159 | 0.36% | 6.5 | 0.0 | 82.6% |
| | | | | | | | | | | | g | [symbol] ot1.160 | 0.31% | 9 | 0.0 | 85.0% |
| | 4/30 | 204 | 17, 18 | | | | | | | | h | [symbol] ot1.161 | 0.21% | 24 | 0.0 | 89.8% |

Increased the voltage

| | | | | | | | | | | | | | | | | |
|---|---|---|---|---|---|---|---|---|---|---|---|---|---|---|---|---|
| 6 | 5/7 | 202 | 19 | 3k | 1.5 cm | 25 + 26 + | Delvac | 2% | 7.29 | 24 | i | [symbol] ot1.171 | 2.06% | 0 | 0.0 | 0.0% |
| | | | | | | 27 | | | | | j | [symbol] ot1.183 | 0.34% | 3 | 0.0 | 83.3% |
| | | | | | | | | | | | n | [symbol] ot1.184 | 0.24% | 6 | 0.0 | 88.4% |
| | | | | | | | | | | | o | [symbol] ot1.185 | 0.14% | 9 | 0.0 | 93.1% |
| | 5/8 | | 20 | | | | | | | | p | [symbol] ot1.198 | 0.15% | 24 | 0.0 | 92.6% |

Increased the voltage

| | | | | | | | | | | | | | | | | |
|---|---|---|---|---|---|---|---|---|---|---|---|---|---|---|---|---|
| 7 | 5/8 | | 21 | 4k | 1.5 cm | 25 + 26 + | Delvac | 2% | 7.29 | 24 | i | [symbol] ot1.170 | 1.97% | 0 | 0.0 | 0.0% |
| | | | | | | 27 | | | | | q | [symbol] ot1.195 | 0.28% | 3 | 0.0 | 85.8% |
| | | | | | | | | | | | r | [symbol] ot1.196 | 0.22% | 6 | 0.0 | 88.7% |
| | | | | | | | | | | | s | [symbol] ot1.197 | 0.21% | 9 | 0.0 | 89.2% |
| | 5/9 | 208 | 22 | | | | | | | | t | [symbol] ot1.198 | 0.17% | 36 | 0.0 | 91.4% |

Increased the voltage

| | | | | | | | | | | | | | | | | |
|---|---|---|---|---|---|---|---|---|---|---|---|---|---|---|---|---|
| 8 | 5/11 | | 23 | 5k | 1.5 cm | 25 + 26 + | Delvac | 2% | 9.12 | 30 | u | [symbol] ot1.199 | 2.05% | 0 | 0.0 | 0.0% |
| | | | | | | 27 | | | | | v | [symbol] ot1.200 | 0.57% | 1 | 0.0 | 72.2% |
| | | | | | | | | | | | w | [symbol] ot1.201 | 0.38% | 2 | 0.0 | 81.3% |
| | | | | | | | | | | | x | [symbol] ot1.202 | 0.28% | 3 | 0.0 | 86.1% |
| | | | | | | | | | | | y | [symbol] ot1.204 | 0.17% | 6 | 0.0 | 91.7% |
| | | | | | | | | | | | z | [symbol] ot1.205 | 0.18% | 9 | 0.0 | 91.0% |
| | 5/12 | 208 | 24-26 | | | | | | | | a | [symbol] ot1.206 | 0.15% | 24 | 0.0 | 92.7% |

[symbol]

indicates data missing or illegible when filed

TABLE II

| Run | | | | | Fram | | Set % | Sooty Oil/ | | Sample | TGA | |
|---|---|---|---|---|---|---|---|---|---|---|---|---|
| No. | Date | Temp | Volt | Space | No. | Diluent | Soot | Ttl Mix (g) | | ID | File | Soot |
| 1 | 11/18 | | 5 kV | 1.5 cm | 22 | Delvac | 3.0% | 14.2 | 24.0 | a | [symbol] t.670 | 3.03% |
| | | 95 C. | | | | | | | | b | [symbol] t.671 | 1.42% |
| 2 | 11/18 | | 5 kV | 1.5 cm | 22 | Delvac | 3.0% | 14.2 | 24.0 | c | [symbol] t.672 | 3.05% |
| | | 92 C. | | | | | | | | d | [symbol] t.673 | 1.33% |
| 3 | 11/19 | | 5 kV | 1.5 cm | 22 | Delvac | 3.0% | 14.2 | 24.0 | e | [symbol] t.674 | 3.04% |
| | | 98 C. | | | | | | | | f | [symbol] t.675 | 1.39% |
| 4 | 11/19 | | 5 kV | 1.5 cm | 22 | Delvac | 2.0% | 9.5 | 24.0 | g | [symbol] t.676 | 2.05% |
| | | 98 C. | | | | | | | | h | [symbol] t.677 | 0.83% |
| 5 | 11/20 | | 5 kV | 1.5 cm | 22 | Delvac | 3.0% | 14.2 | 24.0 | i | [symbol] t.678 | 3.04% |
| | | 96 C. | | | | | | | | j | [symbol] t.679 | 1.57% |
| | | 96 C. | | | | | | | | k | [symbol] t.680 | 1.48% |
| | | 96 C. | | | | | | | | k1 | [symbol] t.681 | 1.40% |
| | | 96 C. | | | | | | | | k2 | [symbol] t.682 | 1.18% |
| 6 | 11/21 | | 5 kV | 1.5 cm | 22 | Delvac | 2.0% | 9.5 | 24.0 | l | [symbol] t.683 | 2.08% |
| | | 97 C. | | | | | | | | m | [symbol] t.684 | 1.01% |
| 7 | 11/21 | | 5 kV | 1.5 cm | 22 | Delvac | 2.0% | 9.5 | 24.0 | n | [symbol] t.685 | 2.06% |
| | | 95 C. | | | | | | | | o | [symbol] t.686 | 1.32% |
| | 11/23 | 98 C. | | | | | | | | p | [symbol] t.687 | 1.16% |
| | 11/24 | 97 C. | | | | | | | | q | [symbol] t.688 | 1.10% |

The sump beaker was put into a larger beaker with oil in it to minimize the temperature gradient
of the sump oil. Pictures of various parts of to this setup are 100-123.

| | | | | | | | | | | | | |
|---|---|---|---|---|---|---|---|---|---|---|---|---|
| 8 | 11/24 | | 5 kV | 1.5 cm | 22 | Delvac | 3.0% | 14.2 | 24.0 | r | [symbol] t.689 | 3.15% |
| | | 97 C. | | | | | | | | s | [symbol] t.690 | 0.81% |
| 9 | 11/25 | | 5 kV | 1.5 cm | 22 | Delvac | 3.0% | 14.2 | 24.0 | t | [symbol] t.691 | 3.05% |
| | | 98 C. | | | | | | | | u | [symbol] t.692 | 1.09% |
| 10 | 11/26 | | 5 kV | 1.5 cm | 22 | Delvac | 3.0% | 14.2 | 24.0 | v | [symbol] t.693 | 2.83% |
| | | 97 C. | | | | | | | | w | [symbol] t.694 | 0.69% |
| 11 | 11/26 | | 5 kV | 1.5 cm | 22 | Delvac | 3.0% | 14.2 | 24.0 | x | [symbol] t.695 | 3.04% |
| | | 91 C. | | | | | | | | y | [symbol] t.696 | 0.67% |

The sump beaker was put into a larger dish with oil in it to minimize the temperature gradient
of the sump oil.

| | | | | | | | | | | | | |
|---|---|---|---|---|---|---|---|---|---|---|---|---|
| 12 | 12/2 | | 5 kV | 1.5 cm | 22 | Delvac | 3.0% | 14.2 | 24.0 | z | [symbol] t.697 | 3.06% |
| | | 98 C. | | | | | | | | a | [symbol] t.698 | 1.05% |
| 13 | 12/3 | | 5 kV | 1.5 cm | 22 | Delvac | 3.0% | 14.2 | 24.0 | b | [symbol] t.699 | 3.05% |
| | | 95 C. | | | | | | | | c | [symbol] t.700 | 1.40% |

The power supply was switched to the Matsusada power supply.

| | | | | | | | | | | | | |
|---|---|---|---|---|---|---|---|---|---|---|---|---|
| 14 | 12/9 | | 5 kV | 1.5 cm | 22 | Delvac | 3.0% | 14.2 | 24.0 | d | [symbol] t.701 | 3.09% |
| | | 99 C. | | | | | | | | e | [symbol] t.702 | 0.82% |
| 15 | 12/10 | | 7 kV | 1.5 cm | 22 | Delvac | 3.0% | 14.2 | 24.0 | f | [symbol] t.704 | 3.08% |
| | | 98 C. | | | | | | | | g | [symbol] t.705 | 1.07% |
| 16 | 12/11 | | 5 kV | 1.5 cm | 22 | [symbol] | 3.0% | 14.2 | 24.0 | i | [symbol] t.707 | 3.03% |
| | | 96 C. | | | | see | | | | j | [symbol] t.708 | 0.18% |
| | | | | | | [symbol] | | | | | | |
| 17 | 12/12 | | 7 kV | 1.5 cm | 22 | Delvac | 3.0% | 14.2 | 24.0 | k | [symbol] t.709 | 3.05% |
| | | 97 C. | | | | | | | | l | [symbol] t.710 | 1.00% |
| 18 | 12/15 | | 7 kV | 1.5 cm | 22 | Delvac | 3.0% | 14.2 | 24.0 | o | [symbol] t.711 | 3.03% |
| | | 96 C. | | | | | | | | p | [symbol] t.712 | 0.24% |
| 19 | 12/16 | | 5 kV | 1.5 cm | 22 | Delvac | 3.0% | 70.5 | 120 | q | [symbol] t.713 | 3.02% |
| | | 94 C. | | | | | | | | r | [symbol] t.714 | 1.15% |
| 20 | 12/16 | | 5 kV | 1.5 cm | 22 | Delvac | 3.0% | 70.5 | 120 | s | [symbol] t.715 | 3.02% |
| | | 101 C. | | | | | | | | t | [symbol] t.716 | 2.26% |
| 21 | 12/17 | | 5 kV | 1.5 cm | 22 | Delvac | 3.0% | 14.1 | 24.0 | u | [symbol] t.718 | 3.03% |
| | | 96 C. | | | | | | | | v | [symbol] t.719 | 0.25% |
| 22 | 12/17 | | 5 kV | 1.5 cm | 22 | Delvec | 3.0% | 14.1 | 24.0 | w | [symbol] t.720 | 3.02% |
| | | 96 C. | | | | | | | | x | [symbol] t.721 | 0.30% |
| 23 | 12/18 | | 5 kV | 1.5 cm | 22 | Delvac | 3.0% | 91.7 | 156 | z | [symbol] t.722 | 3.05% |
| | | 97 C. | | | | | | | | a | [symbol] t.723 | 2.01% |
| | | 97 C. | | | | | | | | b | [symbol] t.724 | 1.90% |
| | | 97 C. | | | | | | | | c | [symbol] t.725 | 1.50% |
| | 12/19 | 97 C. | | | | | | | | d | [symbol] t.734 | 1.58% |
| | | 97 C. | | | | | | | | e | [symbol] t.736 | 1.49% |
| 24 | 12/22 | | 5 kV | 1.5 cm | 22 | Rotella | 2.0% | 9.5 | 24 | g | [symbol] t.737 | 1.98% |
| | | 96 C. | | | | | | | | h | [symbol] t.738 | 0.21% |
| | 12/23 | 96 C. | 10 kV | | | | | | | i | [symbol] t.739 | 0.17% |

| Run | Duration | Current | % Soot | | | |
|---|---|---|---|---|---|---|
| No. | (hrs) | (mA) | removed | Pic | Notes | Equip't |
| 1 | | 0.0 | | | | S74 |
| | 3 | 0.0 | 53.1% | 1 | | |
| 2 | | 0.0 | | | | |
| | 3 | 0.0 | 56.5% | 2 | | |
| 3 | | 0.0 | | | | |
| | 3 | 0.0 | 54.4% | 3 | | |
| 4 | | 0.0 | | | | |
| | 3 | 0.0 | 59.6% | 4 | | |
| 5 | | 0.0 | | | | |
| | 3 | 0.0 | 48.4% | | | |
| | 6 | 0.0 | 51.4% | | | |
| | 9 | 0.0 | 54.0% | | | |
| | 24 | 0.0 | 61.2% | 5 | | |
| 6 | | 0.0 | | | | |
| | 3 | 0.0 | 51.6% | 6 | | |
| 7 | | 0.0 | | | | |
| | 3 | 0.0 | 36.1% | | | |
| | 44 | 0.0 | 43.9% | | | |
| | 63 | 0.0 | 46.6% | 7 | | |

The sump beaker was put into a larger beaker with oil in it to minimize the temperature gradient
of the sump oil. Pictures of various parts of to this setup are 100-123.

| | | | | |
|---|---|---|---|---|
| 8 | | 0.0 | | |
| | 3 | 0.0 | 74.2% | 8 |
| 9 | | 0.0 | | |
| | 6 | 0.0 | 64.2% | 9 |
| 10 | | 0.0 | | |
| | 3 | 0.0 | 75.5% | 10 |
| 11 | | 0.0 | | |
| | 3 | 0.0 | 78.0% | 11 |

The sump beaker was put into a larger dish with oil in it to minimize the temperature gradient
of the sump oil.

| | | | | |
|---|---|---|---|---|
| 12 | | 0.0 | | |
| | 3 | 0.0 | 65.6% | 12 |
| 13 | | 0.0 | | |
| | 3 | 0.0 | 54.0% | 13 |

The power supply was switched to the Matsusada power supply.

| | | | | | |
|---|---|---|---|---|---|
| 14 | | 0.0 | | | |
| | 3 | 0.0 | 73.5% | 14 | |
| 15 | | 0.0 | | | |
| | 3 | 0.0 | 65.3% | 15 | |
| 16 | | 0.0 | | | The Delvac in this sample came |
| | 3 | 0.1 | 94.1% | 16 | from Morristown's Delvac |
| 17 | | 0.0 | | | The positive electrode was wrap- |
| | 3 | 0.0 | 67.3% | 17-19 | ped once with OS 070403 media. |
| 18 | | 0.0 | | | The positive electrode was wrap- |
| | 3 | 0.0 | 91.9% | 20-23 | ped thrice with OS 070403 |
| 19 | | 0.0 | | | The electrodes were horizontal |
| | 3 | 0.0 | 61.7% | 24-25 | with the positive lowest. This |
| | | | | | Soot reading is suspect. |
| 20 | | 0.0 | | | The electrodes were horizontal |
| | 3 | 0.0 | 25.2% | 26 | with the negative lowest. Quite a |
| | | | | | bit of soot was on the bottom of |
| | | | | | the beaker. |
| 21 | | 0.0 | | | The positive electrode was wrap- |
| | 3 | 0.0 | 91.7% | 27-30 | ped with 5 layers of OS 070403 |
| | | | | | media. |
| 22 | | 0.0 | | | The positive electrode was wrap- |
| | 4 | 0.0 | 90.2% | 31 | ped with 7 layers of OS 070403 |
| | | | | | media. |
| 23 | | 0.0 | | | The positive electrode was wrap- |
| | 3 | 0.0 | 34.0% | | ped with 7 layers of OS 070403 |
| | | | | | media. The sump beaker was |
| | | | | | increased to 250 mL |
| | 4.5 | 0.0 | 37.6% | | |
| | 6 | 0.0 | 50.7% | | |
| | 9 | 0.0 | 48.3% | | Ater 6 hrs the run was stopped |
| | 12 | 0.0 | 51.2% | | overnight and restarted |
| 24 | | 0.0 | | | The positive electrode was wrap- |
| | 3 | 0.0 | 89.3% | 32-33 | ped with 5 layers of OS 070403 |
| | 6 | 0.1 | 91.4% | 34-35 | |

[symbol]

indicates data missing or illegible when filed

TABLE III
The data from Table III was used to create the graph illustrated in FIG. 21.

| Duration | | | | | | | | |
|---|---|---|---|---|---|---|---|---|
| (hrs) | 5 kV | 4 kV | 3 kV | 2 kV | 1 kV | 500 V | 250 | 130 |
| 0 | 0.00% | 0.00% | 0.00% | 0.0% | 0.00% | 0.00% | 0.00% | 0.00% |
| 1 | 72.24% | | | | | | | |
| 2 | 81.27% | | | | | | | |
| 3 | 86.14% | 85.78% | 83.31% | | 43.80% | 25.86% | 17.35% | 13.42% |
| 4.6 | | | | 79.2% | | | | |
| 6 | 91.66% | 88.71% | 88.45% | | 65.50% | 42.69% | 28.54% | 17.59% |
| 6.5 | | | | 82.6% | | | | |
| 9 | 91.02% | 89.24% | 93.05% | 85.0% | 71.20% | 52.25% | 34.57% | |
| 11 | | | | | | | | 28.92% |
| 16 | | | | | | | | |
| 24 | 92.67% | | 92.60% | 89.8% | 85.90% | 73.66% | 56.23% | 40.21% |
| 36 | | 91.41% | | | | | | |
| 48 | | | | | | | | 55.58% |
| 52 | | | | | | | 71.61% | |
| 72 | | | | | | | | 64.03% |
| 102 | | | | | | | | |
| 144 | | | | | | | | 76.0% |

TABLE IV

| | | | | Initial | | % soot | Test |
|---|---|---|---|---|---|---|---|
| S. No | P'burg | M'town | Contaminant | % Soot | Diluent | removed | duration |
| 4 | | X | Fram 22 | 2 | Delvac CI-4 | 85 | 3 hrs |
| 5 | | X | Fram 22 | 2 | Delvac CI-4 | 86 | 3 hrs |
| 6 | | X | Fram 22 | 2 | Delvac CI-4 | 87 | 3 hrs |
| 7 | X | | Fram 22 | 3 | Delvac CJ-4 | 56 | 3 hrs |
| 8 | | X | Fram 22 | 3 | Delvac CI-4 | 89 | 3 hrs |
| 9 | | X | Fram 22 | 3 | Delvac CI-4 | 89 | 3 hrs |
| 10 | | X | Fram 22 | 3 | Delvac CI-4 | 89 | 3 hrs |
| 11 | X | | Fram 22 | 3 | Delvac CJ-4 | 53.1 | 3 hrs |
| 12 | X | | Fram 22 | 3 | Delvac CJ-4 | 56.5 | 3 hrs |
| 13 | X | | Fram 22 | 3 | Delvac CJ-4 | 54.4 | 3 hrs |
| 14 | X | | Fram 22 | 3 | Delvac CJ-4 | 74.2 | 3 hrs |
| 15 | X | | Fram 22 | 3 | Delvac CJ-4 | 75.5 | 3 hrs |
| 16 | X | | Fram 22 | 3 | Delvac CJ-4 | 78 | 3 hrs |
| 17 | X | | Fram 22 | 3 | Delvac CJ-4 | 64.2 | 6 hrs |
| 18 | X | | Fram 22 | 3 | Delvac CJ-4 | 65.6 | 3 hrs |
| 19 | X | | Fram 22 | 3 | Delvac CJ-4 | 54 | 3 hrs |
| 20 | X | | Fram 22 | 3 | Delvac CI-4 | 94 | 3 hrs |
| 21 | X | | Fram 22 | 3 | Delvac CJ-4 | 67.3 | 3 hrs |
| 22 | X | | Fram 22 | 3 | Delvac CJ-4 | 91.9 | 3 hrs |
| 23 | X | | Fram 22 | 3 | Delvac CJ-4 | 91.7 | 3 hrs |
| 24 | X | | Fram 22 | 3 | Delvac CJ-4 | | 4 hrs |
| 25 | X | | Fram 22 | 3 | Delvac CJ-4 | | 3 hrs |
| 26 | X | | Fram 22 | 3 | Delvac CJ-4 | | 3 hrs |
| 27 | X | | Fram 22 | 2 | Delvac CJ-4 | 50.70% | 6 hrs |
| 28 | X | | Fram 22 | 2 | Rotella CJ-4 | 90% | 3 hrs |
| 29 | X | | Fram 22 | 2 | Delvac CJ-4 | 9.90% | 4 hrs |
| | | | (17 liters) | | | | |
| 30 | | X | Fram 21 (T-12) | 5.70% | Delvac | 18% | 3 hrs |
| 31 | | X | Fram 4 (T-12) | 5.80% | Delvac | 9% | 3 hrs |
| 32 | | X | Fram 8 (T-12) | 5.40% | Delvac | 20% | 3 hrs |
| 33 | | X | Fram 22 | 3 | Delvac | 35% | 3 hrs-Flow- |
| | | | | | | | 2 ml/min |

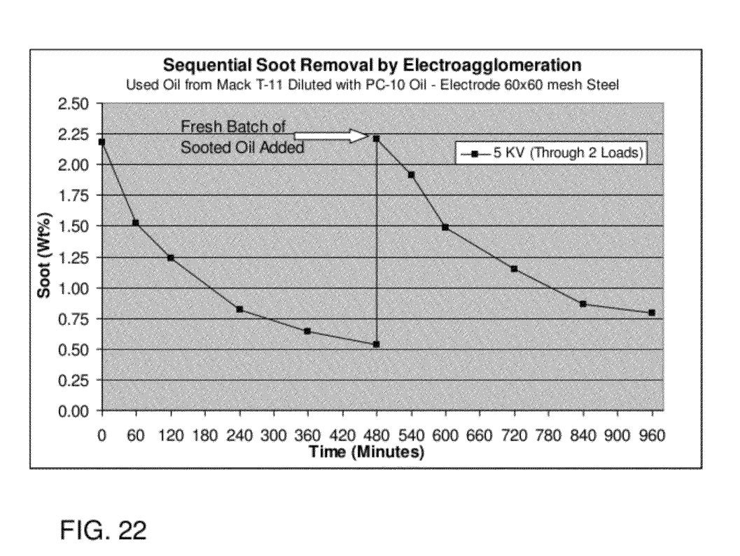

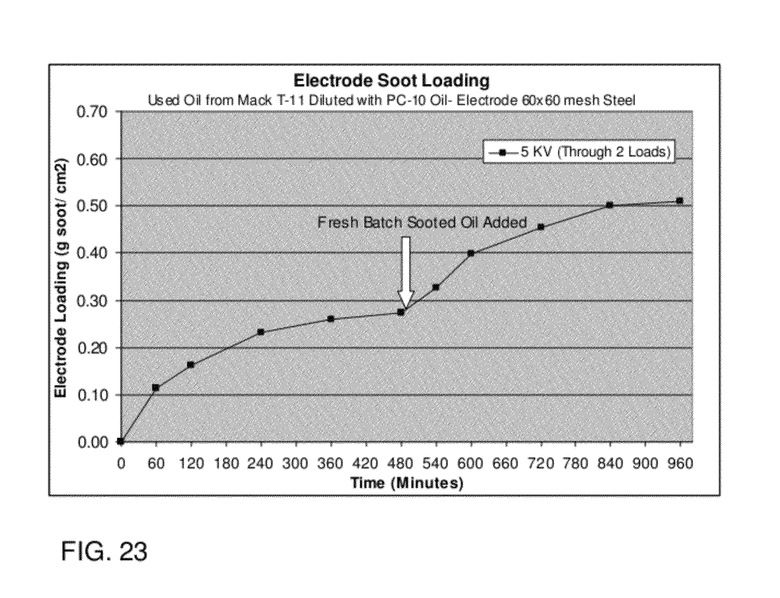

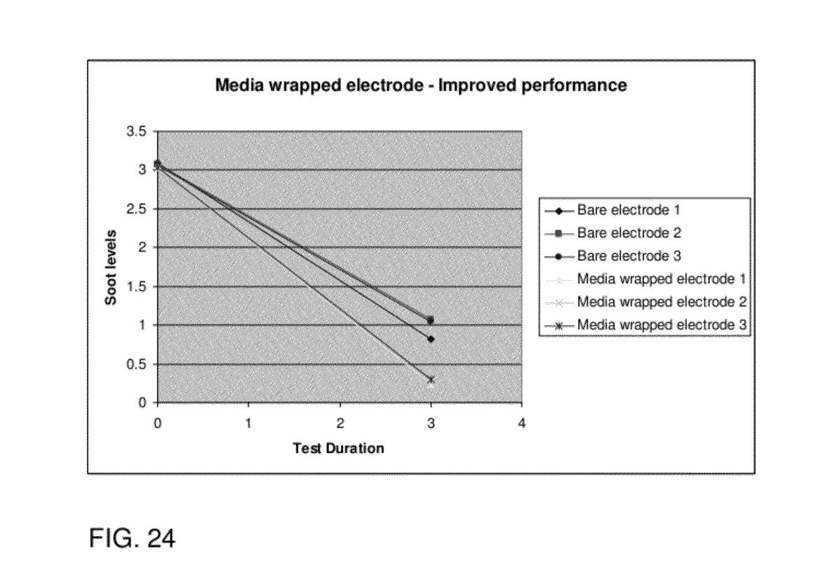

FIG. 22 illustrates sequential soot removal by electroagglomeration and FIG. 23 illustrates the electrode soot loading for sequential soot removal. FIG. 24 illustrates, the improved performance achieved with media wrapped electrodes versus bare electrodes.

Exemplary implementations include onboard transportation applications as well as static applications to control the soot levels in lubricating oils. While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims and their legal equivalence.

What is claimed is:

1. A method for removing soot, sludge and other insoluble particulates from engine oil, the method comprising:
disposing an oil containing the particulates between a pair of electrodes, wherein one of the electrodes is a positive electrode;
wrapping a surface of the positive electrode with a media, wherein the media is configured to collect a portion of the particulates drawn towards the positive electrode;
applying a direct current to the electrodes for a period of time to generate an electric field, wherein the electric field causes a portion of the particulates to agglomerate in the media; and
removing the media and the portion of particulates agglomerated in the media to reduce the amount of soot particles in the oil.

2. The method as in claim 1, wherein the particulates are soot particles and the electric field causes the soot particles to agglomerate resulting in a larger average particle size of the soot particles and the soot particles are removed by a filtering process.

3. The method as in claim 2, wherein the filtering process comprises application of a centrifugal force to the oil, wherein the centrifugal force causes the soot particles to be disposed upon a surface that is removable from the oil.

4. The method as in claim 3, wherein the surface is located on the positive electrode and the positive electrode comprises a portion of a device configured for applying the centrifugal force.

5. The method as in claim 1, wherein the media is selected from the group consisting or woven and nonwoven fibrous materials, comprising any one of the following or combinations thereof: organic fibers, natural or synthetic fibers made from cellulose, polyolefins, polyesters, polyamides; inorganic fibers, metallic and ceramic fibers, stainless steel fibers, alumina and spun glass and silica fibers.

6. The method as in claim 5, wherein the pair of electrodes are configured as a pair of concentric cylinders and wherein one of the pair of electrodes is inserted into the other one of the pair of electrodes and the pair of electrodes are positioned in a facing spaced relationship with respect to each other,

7. The method as in claim 1, wherein the media is selected from the group consisting of open cell organic and inorganic foams made from polyurethanes, polyolefins, polyesters, polyamides; sintered ceramics, alumina or silica; and combinations thereof.

8. The method as in claim 7, wherein the pair of electrodes are configured as a pair of concentric cylinders and wherein one of the pair of electrodes is inserted into the other one of the pair of electrodes and the pair of electrodes are positioned in a facing spaced relationship with respect to each other,

9. A method for removing soot from engine oil, the method comprising:
disposing an oil containing soot particles between a pair of electrodes;
applying a DC or AC current to the pair of electrodes for a period of time to generate an electric field, wherein the electric field causes the soot particles to agglomerate resulting in a larger average particle size of the soot particles; and
removing the soot particles by a filtering process, wherein the filtering process comprises application of a centrifugal force to the oil, wherein the centrifugal force causes the soot particles to be disposed in a media disposed on one of the pair of electrodes that is removable from the oil.

10. The method as in claim 9, wherein the media is disposed on a positive electrode of one of the pair of electrodes and the positive electrode comprises a portion of a device configured for applying the centrifugal force.

11. The method as in claim 10, wherein the media is selected from the group consisting or woven and nonwoven fibrous materials, comprising any one of the following or combinations thereof: organic fibers, natural or synthetic fibers made from cellulose, polyolefins, polyesters, polyamides; inorganic fibers, metallic and ceramic fibers, stainless steel fibers, alumina and spun glass and silica fibers.

12. The method as in claim 11, wherein the pair of electrodes are configured as a pair of concentric cylinders and wherein one of the pair of electrodes is inserted into the other one of the pair of electrodes and the pair of electrodes are positioned in a facing spaced relationship with respect to each other,

13. The method as in claim 10, wherein the media is selected from the group consisting of open cell organic and inorganic foams made from polyurethanes, polyolefins, polyesters, polyamides; sintered ceramics, alumina or silica; and combinations thereof.

14. The method as in claim 13, wherein the pair of electrodes are configured as a pair of concentric cylinders and wherein one of the pair of electrodes is inserted into the other one of the pair of electrodes and the pair of electrodes are positioned in a facing spaced relationship with respect to each other,

15. A filter for removing soot particles from an engine oil having soot particles disposed therein, the filter comprising:
a housing having an inlet and an outlet defining a flow path through a chamber defined by the housing;
a pair of electrodes disposed in the flow path, the electrodes being disposed in the flow path after the inlet, the pair of electrodes being electrically coupled to a DC current, wherein an electric field is generated by the pair of electrodes and one of the pair of electrodes is a positive electrode, wherein the electric field causes a portion of the soot particles to agglomerate on the positive electrode, wherein at least the positive electrode is removable from the filter to allow removal of the soot particles agglomerated on the positive electrode; and
a media applied to the surface of the positive electrode, wherein the media is configured to improve the collecting efficiency of the agglomerated portion of soot particles on the positive electrode.

16. The filter as in claim 15, wherein the positive electrode is formed of stainless steel, copper, aluminum, platinum or other electrically conducting material.

17. The filter as in claim 15, wherein the media is selected from the group consisting or woven and nonwoven fibrous materials, comprising any one of the following or combinations thereof: organic fibers, natural or synthetic fibers made from cellulose, polyolefins, polyesters, polyamides; inorganic fibers, metallic and ceramic fibers, stainless steel fibers, alumina and spun glass and silica fibers.

18. The filter as in claim 15, wherein the pair of electrodes are configured as a pair of concentric cylinders and wherein one of the pair of electrodes is inserted into the other one of the pair of electrodes and the pair of electrodes are positioned in a facing spaced relationship with respect to each other,

19. The filter as in claim 15, wherein the media is selected from the group consisting of open cell organic and inorganic foams made from polyurethanes, polyolefins, polyesters, polyamides; sintered ceramics, alumina or silica; and combinations thereof.

20. The filter as in claim 19, wherein the pair of electrodes are configured as a pair of concentric cylinders and wherein one of the pair of electrodes is inserted into the other one of the pair of electrodes and the pair of electrodes are positioned in a facing spaced relationship with respect to each other and wherein the filter further comprises a rotatable member capable of applying a centrifugal force to the oil and wherein the media and the positive electrode are coupled to the rotatable member.
